(19) United States
(12) Patent Application Publication
(10) Pub. No.: US 2026/0296403 A1
(43) Pub. Date: Oct. 1, 2026

(54) VEHICLE DATA PROCESSING METHOD, AUTONOMOUS VEHICLE, AND COMPUTER-READABLE STORAGE MEDIUM

(71) Applicant: UBTECH ROBOTICS CORP LTD, Shenzhen (CN)

(72) Inventors: Mingli Zhang, Shenzhen (CN); Jinbing Xiong, Shenzhen (CN)

(21) Appl. No.: 19/571,571

(22) Filed: Mar. 19, 2026

(30) Foreign Application Priority Data
Mar. 26, 2025 (CN) 202510377447.9

(51) Int. Cl. B60W 30/02; B60W 50/00; B60W 60/00

(52) U.S. Cl. CPC B60W 30/02; B60W 50/0097; B60W 60/001; B60W 2050/0008; B60W 2050/0022; B60W 2510/20; B60W 2520/10; B60W 2520/14; B60W 2520/20; B60W 2530/201; B60W 2552/40; B60W 2556/45

(57) ABSTRACT

A vehicle data processing method, an autonomous vehicle, and a computer-readable storage medium are provided. The method includes: constructing a phase plane diagram based on a yaw rate and a vehicle sideslip angle of the vehicle during driving; identifying a first region in the phase plane diagram; predicting lateral stability constraint information of the vehicle state within a preset horizon based on the first region; obtaining a first control quantity through receding horizon control based on the lateral stability constraint information and a cost function of a vehicle model predictive controller; and obtaining a second control quantity based on the first control quantity and a feedback compensation control quantity of the vehicle, and controlling the vehicle to perform closed-loop trajectory tracking based on the second control quantity and a reference trajectory. In this manner, the vehicle's safety, stability and tracking accuracy are improved.

### CROSS REFERENCE TO RELATED APPLICATIONS

The present disclosure claims priority to Chinese Patent Application No. 202510377447.9, filed Mar. 26, 2025, which is hereby incorporated by reference herein as if set forth in its entirety.

### TECHNICAL FIELD

The present disclosure relates to autonomous driving control technology, and particularly to a vehicle data processing method, an autonomous vehicle, and a computer-readable storage medium.

### BACKGROUND

Vehicle trajectory tracking refers to the precise control of the traveling path of a vehicle by the control system during driving, enabling the vehicle to follow a predetermined trajectory. With the rapid development of autonomous driving technology, the vehicle trajectory tracking has become a key research field. For ensuring safety and efficiency, autonomous vehicles need to accurately track the predetermined path. It is not only related to the performance and safety of the vehicles but also serves as the foundation for the development of Intelligent Transportation Systems (ITS) and autonomous driving technology.

In the prior art, autonomous driving control technology enables the vehicles to track the desired trajectory by using a Model Predictive Controller (MPC) to predict the optimal control input within a limited prediction horizon. However, under extreme operating conditions such as high-speed driving, this technology fails to guarantee the vehicle's safety and stability. Furthermore, in the application of MPC, the errors arising from the vehicle parameter variations, external disturbances and modeling parameters significantly degrade the trajectory tracking accuracy of the vehicles.

### BRIEF DESCRIPTION OF DRAWINGS

In order to explain the technical schemes in the embodiments of the present disclosure more clearly, the drawings needed to be used in the descriptions of the embodiments or the prior art will be briefly introduced below.

FIG. 1 is a schematic diagram of an application mode of a vehicle data processing method according to an embodiment of the present disclosure;

FIG. 2 is a schematic structural diagram of an electronic device according to an embodiment of the present disclosure;

FIG. 3A is a first schematic flowchart of the vehicle data processing method according to an embodiment of the present disclosure;

FIG. 3B is a second schematic flowchart of the vehicle data processing method according to an embodiment of the present disclosure;

FIG. 3C is a third schematic flowchart of the vehicle data processing method according to an embodiment of the present disclosure;

FIG. 3D is a fourth schematic flowchart of the vehicle data processing method according to an embodiment of the present disclosure;

FIG. 3E is a fifth schematic flowchart of the vehicle data processing method according to an embodiment of the present disclosure;

FIG. 4 is a schematic flowchart of the vehicle data processing method according to an embodiment of the present disclosure.

It should be noted that the aforementioned “first” and “second” are merely for distinguishing different solutions, and do not imply the superiority, inferiority, or implementation priority of the solutions.

### DETAILED DESCRIPTION

To clarify the objectives, technical solutions, and advantages of the present disclosure, the present disclosure is described in further detail hereinafter with reference to the accompanying drawings. The disclosed embodiments are not intended to limit the present disclosure, and all other embodiments that a person of ordinary skill in the art can obtain without exercising inventive step shall be encompassed within the protection scope of the present disclosure.

In the following description, reference is made to “some embodiments,” which describe a subset of all possible embodiments. However, it is to be understood that “some embodiments” may be the same subset or different subsets of all possible embodiments, and may be combined with each other without conflict.

In the following description, the terms “first/second/third” referred to are merely used to distinguish similar objects, and do not represent a specific ordering of the objects. It is to be understood that the “first/second/third” may be interchanged in specific order or sequence where permitted, so that the embodiments of the present disclosure described herein can be implemented in an order other than that illustrated or described herein.

In the embodiments of the present disclosure, the collection and processing of relevant data in practical applications shall strictly comply with the requirements of relevant laws and regulations, obtain the informed consent or separate consent of the personal information subject, and conduct subsequent data use and processing within the scope authorized by the laws and regulations and the personal information subject.

In the embodiments of the present disclosure, the term “module” or “unit” refers to a computer program with predetermined functions, or a part of the computer program, which works with other related parts to achieve predetermined goals, and may be implemented in whole or in part by using software, hardware (such as processing circuits or memories) or a combination thereof. Likewise, one processor (or multiple processors or memories) may be used to implement one or more modules or units. Furthermore, each module or unit may be a part of an integral module or unit including the functions of the module or unit.

Unless otherwise defined, all technical and scientific terms used in the embodiments of the present disclosure have the same meanings as commonly understood by a person of ordinary skill in the art to which they belong. The terms used in the embodiments of the present disclosure are only for the purpose of describing the embodiments of the present disclosure, and are not intended to limit the present disclosure.

Before describing the embodiments of the present disclosure in further detail, explanations are provided for the nouns and terms involved in the embodiments of the present disclosure, and the nouns and terms involved in the embodiments of the present disclosure shall apply to the following explanations.

1. Lateral stability boundary: refers to the limit conditions under which a vehicle can maintain lateral stability during driving.

2. Proportion-Integration-Differentiation (PID) feedback controller: is a closed-loop controller widely used in industrial control systems and vehicle control systems, which includes three main control actions of Proportional (P), Integral (I), and Differential (D), and optimizes the system performance by adjusting the proportions of these three control actions.

3. Model Predictive Controller (MPC): is a controller used to optimize the driving path of the vehicle and improve driving stability and accuracy of the vehicle.

The embodiments of the present disclosure provide a vehicle data processing method, an autonomous vehicle, an apparatus, a device, and a non-transitory computer-readable storage medium, which can guarantee the safety and stability of the vehicle during driving and improve the trajectory tracking accuracy of the vehicle.

The following describes exemplary applications of an electronic device provided in the embodiments of the present disclosure. The electronic device provided in the embodiments of the present disclosure may be implemented as various types of terminals, such as laptop computers, tablet computers, desktop computers, set-top boxes, smartphones, smart speakers, smart watches, smart TVs, vehicle-mounted terminals, etc., and may further be implemented as a server. Below, an exemplary application when the device is implemented as a server will be described.

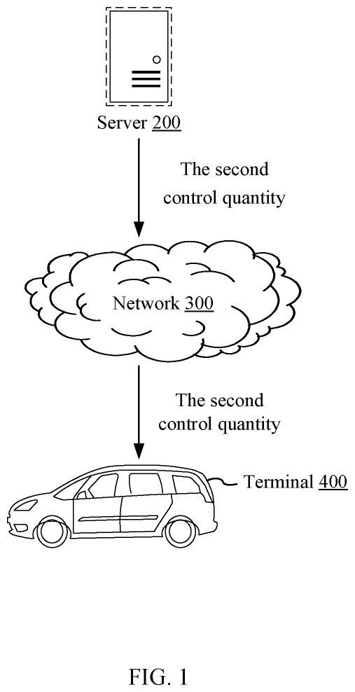

FIG. 1 illustrates a schematic diagram of an application mode of a vehicle data processing method according to an embodiment of the present disclosure. As an example, FIG. 1 shows a server 200, a network 300, and a terminal 400. The terminal 400 is connected to the server 200 through the network 300, and the network 300 may be a wide area network (WAN), a local area network (LAN), or a combination thereof.

In the process of the vehicle trajectory tracking, the server 200 obtains vehicle state variables of a vehicle during driving, the vehicle state variables including a yaw rate and a vehicle sideslip angle (i.e., sideslip angle at the center of gravity of the vehicle), and constructs a phase plane diagram based on the yaw rate and the vehicle sideslip angle; identifies a first region in the phase plane diagram by performing dynamic stability analysis of the vehicle on the phase plane diagram; predicts lateral stability constraint information of the vehicle state within a preset horizon based on boundary characteristics of the first region; designs a cost function of a model predictive controller of the vehicle, and obtains a first control quantity through receding horizon control based on the lateral stability constraint information and the cost function; obtains a feedback compensation control quantity of the vehicle, and obtains a second control quantity by superimposing the first control quantity and the feedback compensation control quantity. The server 200 sends the second control quantity to the terminal 400, and the terminal 400 performs closed-loop trajectory tracking based on the second control quantity and a reference trajectory. The terminal 400 may be an autonomous vehicle.

In some embodiments, the server (for example, the server 200) may be an independent physical server, a server cluster or a distributed system composed of a plurality of physical servers, or a cloud server used for providing basic cloud computing services, such as cloud services, cloud databases, cloud computing, cloud functions, cloud storage, network services, cloud communications, middleware services, domain name services, security services, Content Delivery Network (CDN), big data and artificial intelligence platforms, etc. The terminal 400 may be a smartphone, a tablet computer, a laptop computer, a desktop computer, a smart speaker, a smart watch, a vehicle-mounted terminal, etc., but is not limited thereto. The terminal and the server may be directly or indirectly connected through wired or wireless communication means, which is not limited in the embodiments of the present disclosure.

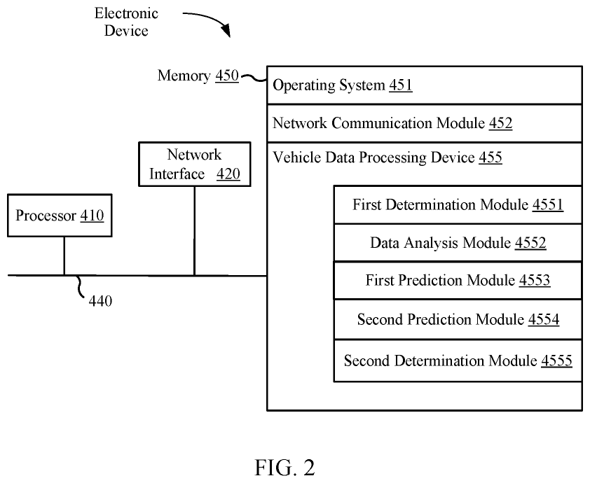

FIG. 2 illustrates a schematic structural diagram of an electronic device according to an embodiment of the present disclosure. The electronic device may be a terminal or a server. As shown in FIG. 2, the electronic device includes: at least one processor 410, a memory 450, and at least one network interface 420. Each component in the electronic device is coupled together through a bus system 440. It is understandable that the bus system 440 is used to implement connection and communication between these components. In addition to a data bus, the bus system 440 further includes: a power bus, a control bus, and a status signal bus. For the sake of clarity, various buses are denoted as the bus system 440 in FIG. 2.

The processor 410 may be an integrated circuit chip with signal processing capabilities, such as a general-purpose processor, a Digital Signal Processor (DSP), another programmable logic device, a discrete gate or transistor logic device, a discrete hardware component, etc. The general-purpose processor may be a microprocessor or any conventional processor.

The memory 450 may be removable, non-removable, or a combination thereof. Exemplary hardware devices include solid-state memory, hard disk drives, optical disk drives, etc. The memory 450 optionally includes one or more storage devices physically remote from the processor 410.

The memory 450 may include a volatile memory and/or a non-volatile memory. The non-volatile memory may be a Read Only Memory (ROM), and the volatile memory may be a Random Access Memory (RAM). The memory 450 described in the embodiments of the present disclosure is intended to include any suitable type of memory.

In some embodiments, the memory 450 can store data to support various operations. Examples of such data include programs, modules, and data structures or subsets or supersets thereof, which are exemplarily described below.

The operating system 451 includes system programs for processing various basic system services and performing hardware-related tasks, such as a framework layer, a core library layer, a driver layer, etc., so as to implement various basic services and process hardware-based tasks.

The network communication module 452 is configured to reach other electronic devices via one or more (wired or wireless) network interfaces 420. Exemplary network interfaces 420 include Bluetooth, Wireless Fidelity (WiFi), and Universal Serial Bus (USB), etc.

In some embodiments, the device provided in the embodiments of the present disclosure may be implemented in software. FIG. 2 shows a vehicle data processing device 455 stored in the memory 450. The vehicle data processing device 455 may be software in the form of programs, plug-ins, etc., and includes a first determination module 4551, a data analysis module 4552, a first prediction module 4553, a second prediction module 4554, and a second determination module 4555. These modules are logical and thus may be arbitrarily combined or further split according to the implemented functions, and the functions of each module will be described below.

Hereinafter, the vehicle data processing method provided in the embodiments of the present disclosure will be described in conjunction with the exemplary applications and implementations of the server device provided in the embodiments of the present disclosure.

Next, the vehicle data processing method provided in the embodiments of the present disclosure will be described. Exemplarily, to facilitate understanding of the vehicle data processing method provided in the embodiments of the present disclosure, the embodiments of the present disclosure take the autonomous vehicle trajectory tracking scenario as an example for description.

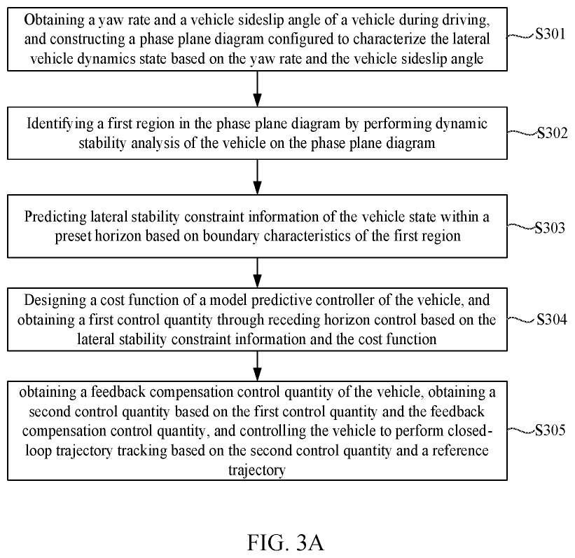

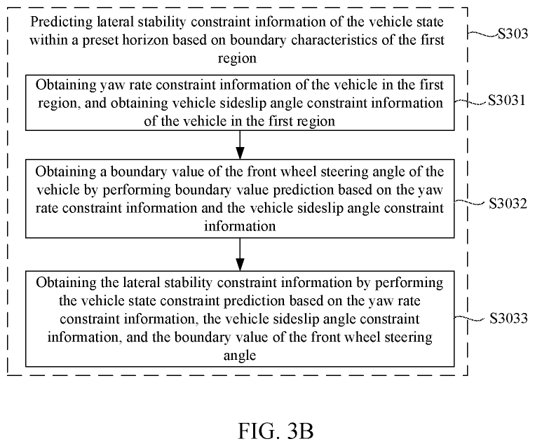

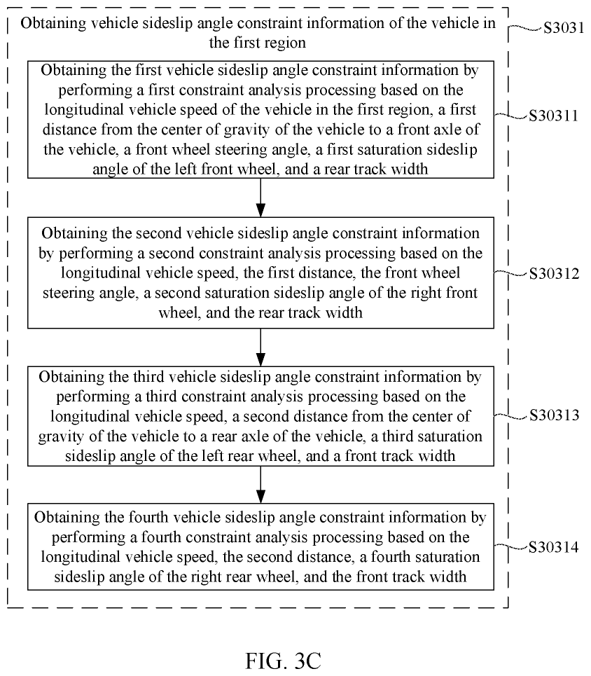

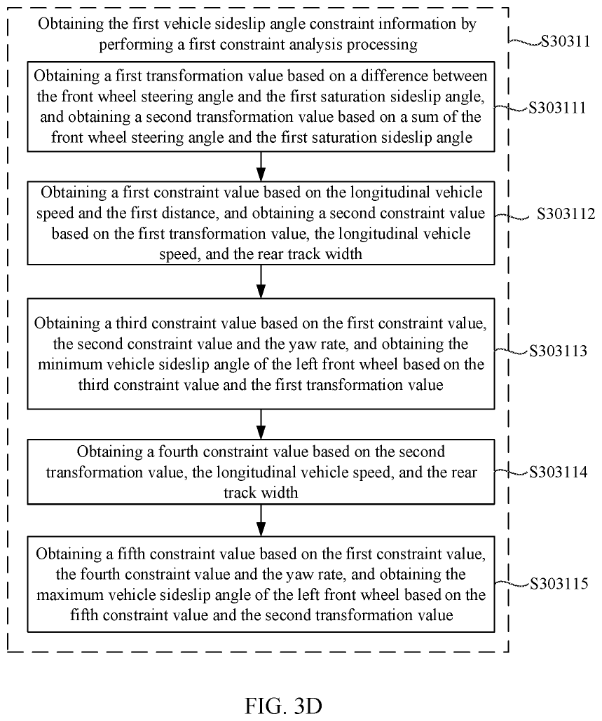

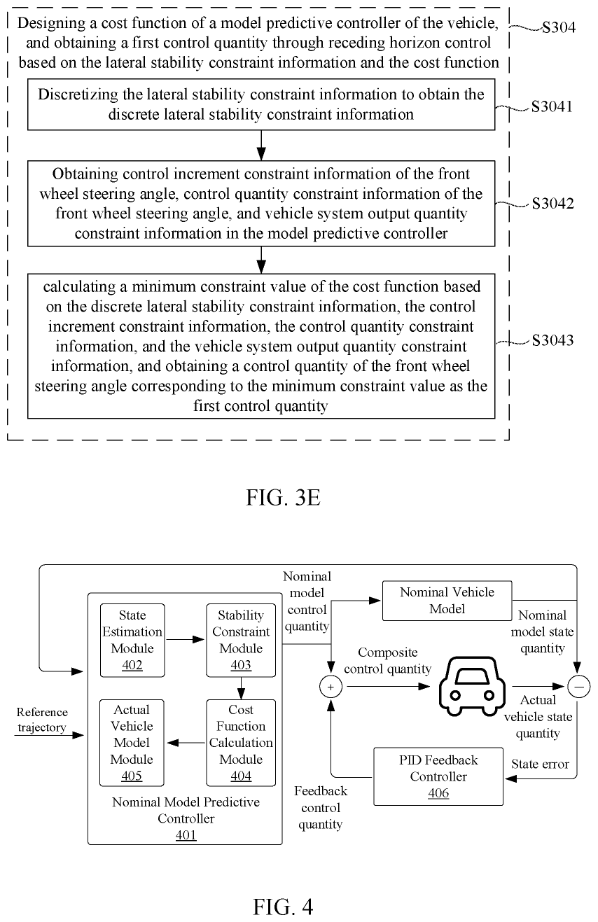

As mentioned above, the electronic device for implementing the vehicle data processing method provided in the embodiments of the present disclosure may be a terminal, a server, or a combination of the two. Next, taking the electronic device as a server as an example, the vehicle data processing method provided in the embodiments of the present disclosure will be described. FIG. 3A illustrates a first schematic flowchart of the vehicle data processing method according to an embodiment of the present disclosure. The following description will be made in conjunction with the steps shown in FIG. 3A.

The vehicle data processing method includes step S301: obtaining a yaw rate and a vehicle sideslip angle of a vehicle during driving, and constructing a phase plane diagram configured to characterize the lateral vehicle dynamics state based on the yaw rate and the vehicle sideslip angle.

The yaw rate is the angular velocity of the vehicle during left or right steering in a horizontal plane. The yaw rate is an important parameter for measuring vehicle handling, and reflects the response speed and stability of the vehicle when turning. The vehicle sideslip angle is a physical parameter that can describe the degree of deviation in vehicle trajectory tracking and characterize the extent of lateral slip of the vehicle. A large vehicle sideslip angle indicates that the vehicle has a significant extent of lateral slip, which will lead to difficult vehicle handling. Thus, the limit value of the vehicle sideslip angle determines the maximum lateral deviation angle for safe vehicle handling. When the vehicle sideslip angle is small, the magnitude of the yaw rate will determine the turning capability of the vehicle. Thus, the stability and turning performance of the vehicle can be characterized through the vehicle sideslip angle and the yaw rate.

The yaw rate of the vehicle during driving can be directly observed by the vehicle sensors, and the vehicle sideslip angle is the physical variable that is difficult to observe. Exemplarily, the vehicle sideslip angle may be obtained by the following formula (1):

$$β = arctan ( {v}_{y} / {v}_{x} ) ; \qquad ( 1 )$$

where, β denotes the vehicle sideslip angle, v_{y} denotes a lateral velocity, and vₓ denotes a longitudinal velocity.

The differential equations for the lateral and yaw motions of the vehicle system may be obtained based on the vehicle dynamics model, and the differential equations related to the vehicle sideslip angle and yaw rate can be derived by simplifying the obtained differential equations. Exemplarily, the differential equations related to the vehicle sideslip angle and yaw rate may be obtained by the following formula (2):

$$\{ \begin{matrix}\dot{β} = \frac{2 {F}_{lf} sin {δ}_{f} + 2 {F}_{cf} cos {δ}_{f} + 2 {F}_{c r}}{m {v}_{x}} - γ \\ \dot{γ} = \frac{2 {L}_{f} ( {F}_{lf} sin {δ}_{f} + {F}_{c f} cos {δ}_{f} ) - 2 {L}_{r} {F}_{c r}}{{I}_{z}}\end{matrix} ; \qquad ( 2 )$$

where \dot{β} denotes the differential of the vehicle sideslip angle, \dot{γ} denotes the differential of the yaw rate, δ_{f} denotes a steering angle of front wheels, m denotes a mass of the vehicle, F_{lf} denotes a longitudinal force acting on the front wheels, F_{cf} denotes a lateral force acting on the front wheels, F_{cr} denotes a lateral force acting on rear wheels, I_{z} denotes a moment of inertia, L_{f} denotes a distance from a center of gravity of the vehicle to a front axle of the vehicle, and Lᵣ denotes a distance from the center of gravity of the vehicle to a rear axle of the vehicle.

The lateral acceleration can be directly observed by the sensors. Exemplarily, the lateral acceleration may be obtained by the following formula (3):

$${a}_{y} = \frac{2 {F}_{lf} sin {δ}_{f} + 2 {F}_{c f} cos {δ}_{f} + 2 {F}_{c r}}{m} ; \qquad ( 3 )$$

where, a_{y} denotes the lateral acceleration, δ_{f} denotes a steering angle of the front wheels, m denotes the mass of the vehicle, F^{lf} denotes the longitudinal force acting on the front wheels, F_{cf} denotes the lateral force acting on the front wheels, and F_{cr} denotes the lateral force acting on the rear wheels.

By combining the differential equations related to the vehicle sideslip angle and the yaw rate with the lateral acceleration, the vehicle sideslip angle during driving can be obtained.

The phase plane diagram is a two-dimensional space consisting of vehicle state variables, and the vehicle state variables include the yaw rate and the vehicle sideslip angle. A phase plane model is obtained by establishing a vehicle dynamics model and performing linearization processing on the vehicle dynamics model. The phase plane diagram is obtained by taking the yaw rate as the abscissa in the phase plane model and the vehicle sideslip angle as the ordinate in the phase plane model. Each point in the phase plane diagram represents a state of the vehicle, that is, the yaw rate and the vehicle sideslip angle at a specific moment.

With continued reference to FIG. 3A, the vehicle data processing method further includes step S302: identifying a first region in the phase plane diagram by performing dynamic stability analysis of the vehicle on the phase plane diagram.

The dynamic stability analysis is used to identify the stable region of the vehicle during driving. The stable region refers to the region in the phase plane diagram where the vehicle can travel along a preset trajectory without deviating from the preset trajectory by more than a threshold distance due to external disturbances or internal factors, that is, the first region.

In some embodiments, identifying a first region in the phase plane diagram by performing dynamic stability analysis of the vehicle on the phase plane diagram may include: obtaining an equilibrium point and N phase trajectories of the vehicle in the phase plane diagram, wherein N is a positive integer; selecting at least one target phase trajectory converging to the equilibrium point from the N phase trajectories; and identifying a region occupied by the at least one target phase trajectory in the phase plane diagram as the first region.

The equilibrium point of the vehicle system is first obtained in the phase plane diagram, and the equilibrium point characterizes a stable state of the vehicle without external disturbances. The equilibrium point usually corresponds to a zero vehicle sideslip angle and a zero yaw rate, representing that the vehicle travels straight without yawing. According to the vehicle dynamics principles, differential equations for describing the lateral and yaw motions of the vehicle are established. The yaw rate and the vehicle sideslip angle are taken as the vehicle state variables that vary with time, the differential equations are solved by using the vehicle state variables, and N phase trajectories of the vehicle under different vehicle state variables are plotted based on the solving results of the differential equations.

The distances between each trajectory point on a phase trajectory and the equilibrium point are obtained. If the distance from the trajectory points on the phase trajectory to the equilibrium point decreases progressively as time elapses, the phase trajectory is determined to converge to the equilibrium point. If the phase trajectory converges to the equilibrium point, it indicates that the vehicle is in a stable state. The at least one phase trajectory converging to the equilibrium point is identified and selected from the N phase trajectories and taken as the target phase trajectory. A region in the phase plane diagram occupied by the at least one target phase trajectory is defined as the region where the vehicle maintains stable driving, that is, the first region.

In the embodiments of the present disclosure, by selecting the at least one target phase trajectory converging to the equilibrium point from the N phase trajectories in the phase plane diagram, and identifying the region occupied by the target phase trajectory as the first region, subsequent vehicle state constraint prediction based on the first region can be conveniently performed, and the safer lateral stability boundary conditions can be obtained.

With continued reference to FIG. 3A, the vehicle data processing method further includes step S303: predicting lateral stability constraint information of the vehicle state within a preset horizon based on boundary characteristics of the first region.

The vehicle state constraint prediction is to predict the lateral stability boundary of the vehicle, and the lateral stability boundary refers to the limit conditions under which the vehicle can maintain lateral stability during driving, i.e., the lateral stability constraint information. Within the lateral stability boundary, the vehicle can travel safely without instability phenomena such as skidding and tail flick.

FIG. 3B illustrates a second schematic flowchart of the vehicle data processing method according to an embodiment of the present disclosure. Step S303 shown in FIG. 3A may be implemented by Steps S3031 to S3033 shown in FIG. 3B. This is described in detail below.

Step S3031 includes: obtaining yaw rate constraint information of the vehicle in the first region, and obtaining vehicle sideslip angle constraint information of the vehicle in the first region.

In step S3031, a yaw rate boundary of the vehicle in the first region is predicted to obtain the yaw rate constraint information, and a boundary of the vehicle sideslip angle of the vehicle in the first region is predicted to obtain the vehicle sideslip angle constraint information.

In some embodiments, the yaw rate constraint information includes a minimum yaw rate and a maximum yaw rate. Obtaining the yaw rate constraint information of the vehicle in the first region may include: obtaining a longitudinal vehicle speed and a road adhesion coefficient of the vehicle in the first region; obtaining the maximum yaw rate based on the longitudinal vehicle speed, the road adhesion coefficient and gravitational acceleration; and obtaining the minimum yaw rate based on the maximum yaw rate.

The longitudinal vehicle speed is the forward speed of the vehicle during driving. The road adhesion coefficient is used to measure the magnitude of friction between the vehicle tires and the road surface. A higher road adhesion coefficient indicates greater friction between the vehicle tires and the road surface, and the likelihood of the vehicle experiencing skidding or loss of control is lower. Optionally, in one embodiment of the present disclosure, when the vehicle travels in the first region, the longitudinal vehicle speed and the road adhesion coefficient of the vehicle are obtained, the maximum yaw rate is obtained by multiplying the longitudinal vehicle speed, the road adhesion coefficient and the gravitational acceleration, and the minimum yaw rate may be obtained by using the maximum yaw rate based a vehicle dynamics formula.

For example, the minimum yaw rate may be obtained by taking the negative of the maximum yaw rate, and the yaw rate boundary may be obtained according to the following formula (4):

$$\{ \begin{matrix}{γ}_{max} = μ g {v}_{x}^{- 1} \\ {γ}_{min} = - μ g {v}_{x}^{- 1}\end{matrix} ; \qquad ( 4 )$$

where, γₘₐₓ denotes the maximum yaw rate, γₘᵢₙ denotes the minimum yaw rate, μ denotes the road adhesion coefficient, vₓ denotes the longitudinal vehicle speed, and g denotes the gravitational acceleration.

In the embodiments of the present disclosure, as the yaw rate constraint information of the vehicle in the first region is obtained by combining the longitudinal vehicle speed, the road adhesion coefficient and the gravitational acceleration of the vehicle in the first region, the safety and stability of the vehicle during left and right steering in a horizontal plane can be ensured.

In some embodiments, the vehicle sideslip angle constraint information includes: first vehicle sideslip angle constraint information of a left front wheel, second vehicle sideslip angle constraint information of a right front wheel, third vehicle sideslip angle constraint information of a left rear wheel, and fourth vehicle sideslip angle constraint information of a right rear wheel. FIG. 3C illustrates a third schematic flowchart of the vehicle data processing method according to an embodiment of the present disclosure. The “obtaining vehicle sideslip angle constraint information of the vehicle in the first region” in step S3031 shown in FIG. 3A may be implemented by Steps S30311 to S30314 shown in FIG. 3C. This is described in detail below.

Step S30311 includes: obtaining the first vehicle sideslip angle constraint information by performing a first constraint analysis processing based on the longitudinal vehicle speed of the vehicle in the first region, a first distance from the center of gravity of the vehicle to a front axle of the vehicle, a front wheel steering angle, a first saturation sideslip angle of the left front wheel, and a rear track width.

In step S30311, the first saturation sideslip angle refers to a sideslip angle corresponding to a tire of the left front wheel when the tire reaches its lateral force limit, and the sideslip angle is an angle between a tire centerline and a vehicle traveling direction. The first constraint analysis processing is to predict a boundary of the vehicle sideslip angle of the left front wheel and obtain the first vehicle sideslip angle constraint information. The first vehicle sideslip angle constraint information includes: a minimum vehicle sideslip angle of the left front wheel, and a maximum vehicle sideslip angle of the left front wheel.

FIG. 3D illustrates a fourth schematic flowchart of the vehicle data processing method according to an embodiment of the present disclosure. Step S30311 shown in FIG. 3C may be implemented by Steps S303111 to S303115 shown in FIG. 3D. This is described in detail below.

Step S303111 includes: obtaining a first transformation value based on a difference between the front wheel steering angle and the first saturation sideslip angle, and obtaining a second transformation value based on a sum of the front wheel steering angle and the first saturation sideslip angle.

The first transformation value and the second transformation value may be obtained based on vehicle dynamics formulas. Optionally, in one embodiment of the present disclosure, the first transformation value may be obtained by performing a tangent function transformation on a difference between the front wheel steering angle and the first saturation sideslip angle, and the second transformation value may be obtained by performing the tangent function transformation on a sum of the front wheel steering angle and the first saturation sideslip angle. Specifically, the difference is obtained by subtracting the first saturation sideslip angle from the front wheel steering angle, and the first transformation value is obtained by applying the tangent function to the difference. For example, the first transformation value may be expressed as tan(δ_{f}−α_{s,lf}), where δ_{f} denotes the front wheel steering angle, and α_{s,lf} denotes the first saturation sideslip angle.

A sum is obtained by adding the front wheel steering angle and the first saturation sideslip angle, and a second transformation value is obtained by applying the tangent function to the sum. For example, the second transformation value may be expressed as tan(δ_{f}+α_{s,lf}).

Step S303112 includes: obtaining a first constraint value based on the longitudinal vehicle speed and the first distance, and obtaining a second constraint value based on the first transformation value, the longitudinal vehicle speed, and the rear track width.

Optionally, in one embodiment of the present disclosure, the first constraint value may be obtained by multiplying the longitudinal vehicle speed by the first distance, and the second constraint value may be obtained by multiplying the first transformation value, the longitudinal vehicle speed, and the rear track width. Optionally, in other embodiments, a reciprocal of the longitudinal vehicle speed may be obtained by performing a reciprocal transformation on the longitudinal vehicle speed. The first constraint value is obtained by multiplying the reciprocal of the longitudinal vehicle speed by the first distance from the center of gravity of the vehicle to the front axle of the vehicle. The second constraint value may be obtained by multiplying one-half of the reciprocal of the longitudinal vehicle speed, the first transformation value, and the rear track width. For example, the first constraint value may be expressed as

$${L}_{f} {v}_{x}^{- 1} ,$$

and the second constraint value may be expressed as

$$1 / 2 {v}_{x}^{- 1} {B}_{r} tan ( {δ}_{f} - {α}_{s , lf} ) ,$$

where L_{f} denotes the first distance, vₓ denotes the longitudinal vehicle speed, Bᵣ denotes the rear track width, and tan(δ_{f}−α_{s,lf}) denotes the first transformation value.

Step S303113 includes: obtaining a third constraint value based on the first constraint value, the second constraint value and the yaw rate, and obtaining the minimum vehicle sideslip angle of the left front wheel based on the third constraint value and the first transformation value.

Optionally, in one embodiment of the present disclosure, the third constraint value may be obtained by multiplying a sum of the first constraint value and the second constraint value by the yaw rate, and a sum of a negative of the third constraint value and the first transformation value may be obtained as the minimum vehicle sideslip angle of the left front wheel. For example, the third constraint value may be expressed as

$$( {L}_{f} {v}_{x}^{- 1} + 1 / 2 {v}_{x}^{- 1} {B}_{r} tan ( {δ}_{f} - {α}_{s , lf} ) ) γ ,$$

and the minimum vehicle sideslip angle may be expressed as

$$- ( {L}_{f} {v}_{x}^{- l} + 1 / 2 {v}_{x}^{- 1} {B}_{r} tan ( {δ}_{f} - {α}_{s , lf} ) ) γ + tan ( {δ}_{f} - {α}_{s , lf} ) ,$$

where γ denotes the yaw rate.

Step S303114 includes: obtaining a fourth constraint value based on the second transformation value, the longitudinal vehicle speed, and the rear track width.

Optionally, in one embodiment of the present disclosure, the fourth constraint value may be obtained by multiplying the second transformation value, the longitudinal vehicle speed, and the rear track width. Optionally, in other embodiments, the fourth constraint value may be obtained by multiplying the second transformation value, one-half of the reciprocal of the longitudinal vehicle speed, and the rear track width. For example, the fourth constraint value may be expressed as

$$1 / 2 {v}_{x}^{- 1} {B}_{r} tan ( {δ}_{f} + {α}_{s , lf} ) .$$

Step S303115 includes: obtaining a fifth constraint value based on the first constraint value, the fourth constraint value and the yaw rate, and obtaining the maximum vehicle sideslip angle of the left front wheel based on the fifth constraint value and the second transformation value.

Optionally, in one embodiment of the present disclosure, the fifth constraint value may be obtained by multiplying a sum of the first constraint value and the fourth constraint value by the yaw rate, and the maximum vehicle sideslip angle of the left front wheel may be obtained by summing a negative of the fifth constraint value and the second transformation value. For example, the fifth constraint value may be expressed as

$$( {L}_{f} {v}_{x}^{- 1} + 1 / 2 {v}_{x}^{- 1} {B}_{r} tan ( {δ}_{f} + {α}_{s , lf} ) ) γ ,$$

and the maximum vehicle sideslip angle may be expressed as

$$- ( {L}_{f} {v}_{x}^{- 1} + 1 / 2 {v}_{x}^{- 1} {B}_{r} tan ( {δ}_{f} + {α}_{s , lf} ) ) γ + tan ( {δ}_{f} + {α}_{s , lf} ) .$$

The first vehicle sideslip angle constraint information of the left front wheel may be obtained by the following formula (5):

$$\{ \begin{matrix}{β}_{{a}_{lf , max}} = - ( {L}_{f} {v}_{x}^{- 1} + 1 / 2 {v}_{x}^{- 1} {B}_{r} tan ( {δ}_{f} + {α}_{s , lf} ) ) γ + tan ( {δ}_{f} + {α}_{s , lf} ) \\ {β}_{{a}_{lf , min}} = - ( {L}_{f} {v}_{x}^{- 1} + 1 / 2 {v}_{x}^{- 1} {B}_{r} tan ( {δ}_{f} - {α}_{s , lf} ) ) γ + tan ( {δ}_{f} - {α}_{s , lf} )\end{matrix} ; \qquad ( 5 )$$

where, βₐ_{_{lf,max}} denotes the maximum vehicle sideslip angle of the left front wheel, and βₐ_{_{lf,min}} denotes the minimum vehicle sideslip angle of the left front wheel.

With continued reference to FIG. 3C, step S30312 includes: obtaining the second vehicle sideslip angle constraint information by performing a second constraint analysis processing based on the longitudinal vehicle speed, the first distance, the front wheel steering angle, a second saturation sideslip angle of the right front wheel, and the rear track width.

In step S30312, the second saturation sideslip angle refers to a sideslip angle corresponding to a tire of the right front wheel when the tire reaches its lateral force limit. The second constraint analysis processing is to predict a boundary of the vehicle sideslip angle of the right front wheel and obtain the second vehicle sideslip angle constraint information. The second vehicle sideslip angle constraint information includes: a minimum vehicle sideslip angle of the right front wheel, and a maximum vehicle sideslip angle of the right front wheel.

For example, the second vehicle sideslip angle constraint information of the right front wheel may be obtained by the following formula (6):

$$\{ \begin{matrix}{β}_{{a}_{rf , max}} = - ( {L}_{f} {v}_{x}^{- 1} - 1 / 2 {v}_{x}^{- 1} {B}_{r} tan ( {δ}_{f} + {α}_{s , rf} ) ) γ + tan ( {δ}_{f} + {α}_{s , rf} ) \\ {β}_{{a}_{rf , min}} = - ( {L}_{f} {v}_{x}^{- 1} - 1 / 2 {v}_{x}^{- 1} {B}_{r} tan ( {δ}_{f} - {α}_{s , rf} ) ) γ + tan ( {δ}_{f} - {α}_{s , rf} )\end{matrix} ; \qquad ( 6 )$$

where, βₐ_{_{rf,max}} denotes the maximum vehicle sideslip angle of the right front wheel, βₐ_{_{rf,min}} denotes the minimum vehicle sideslip angle of the right front wheel, L_{f} denotes the first distance, vₓ denotes the longitudinal vehicle speed, Bᵣ denotes the rear track width, δ_{f} denotes the front wheel steering angle, and a_{s,rf} denotes the second saturation sideslip angle.

Step S30313 includes: obtaining the third vehicle sideslip angle constraint information by performing a third constraint analysis processing based on the longitudinal vehicle speed, a second distance from the center of gravity of the vehicle to a rear axle of the vehicle, a third saturation sideslip angle of the left rear wheel, and a front track width.

In step S30313, the third saturation sideslip angle refers to a sideslip angle corresponding to a tire of the left rear wheel when the tire reaches its lateral force limit. The third constraint analysis processing is to predict a boundary of the vehicle sideslip angle of the left rear wheel to obtain the third vehicle sideslip angle constraint information. The third vehicle sideslip angle constraint information includes: a minimum vehicle sideslip angle of the left rear wheel, and a maximum vehicle sideslip angle of the left rear wheel.

For example, the third vehicle sideslip angle constraint information of the left rear wheel may be obtained by the following formula (7):

$$\{ \begin{matrix}{β}_{{al}_{r , max}} = - ( {L}_{r} {v}_{x}^{- 1} - 1 / 2 {v}_{x}^{- 1} {B}_{f} tan ( {α}_{s , l r} ) ) γ + tan ( {α}_{s , l r} ) \\ {β}_{a {l}_{r , min}} = - ( {L}_{r} {v}_{x}^{- 1} - 1 / 2 {v}_{x}^{- 1} {B}_{r} tan ( {α}_{s , l r} ) ) γ - tan ( {α}_{s , l r} )\end{matrix} ; \qquad ( 7 )$$

where, βₐₗ_{_{r,max}} denotes the maximum vehicle sideslip angle of the left rear wheel, βₐₗ_{_{r,min}} denotes the minimum vehicle sideslip angle of the left rear wheel, Lᵣ denotes the second distance, vₓ denotes the longitudinal vehicle speed, B_{f} denotes the front track width, and a_{s,lr} denotes the third saturation sideslip angle.

Step S30314 includes: obtaining the fourth vehicle sideslip angle constraint information by performing a fourth constraint analysis processing based on the longitudinal vehicle speed, the second distance, a fourth saturation sideslip angle of the right rear wheel, and the front track width.

In step S30314, the fourth saturation sideslip angle refers to a sideslip angle corresponding to a tire of the right rear wheel when the tire reaches its lateral force limit. The fourth constraint analysis processing is to predict a boundary of the vehicle sideslip angle of the right rear wheel to obtain the fourth vehicle sideslip angle constraint information. The fourth vehicle sideslip angle constraint information includes: a minimum vehicle sideslip angle of the right rear wheel, and a maximum vehicle sideslip angle of the right rear wheel.

For example, the fourth vehicle sideslip angle constraint information of the right rear wheel may be obtained by the following formula (8):

$$\{ \begin{matrix}{β}_{{a}_{rr , max}} = - ( {L}_{r} {v}_{x}^{- 1} + 1 / 2 {v}_{x}^{- 1} {B}_{f} tan ( {α}_{s , rr} ) ) γ + tan ( {α}_{s , rr} ) \\ {β}_{{a}_{rr , min}} = - ( {L}_{r} {v}_{x}^{- 1} + 1 / 2 {v}_{x}^{- 1} {B}_{f} tan ( {α}_{s , rr} ) ) γ - tan ( {α}_{s , rr} )\end{matrix} ; \qquad ( 8 )$$

where, βₐ_{_{rr,max}} denotes the maximum vehicle sideslip angle of the right rear wheel, βₐ_{_{rr,min}} denotes the minimum vehicle sideslip angle of the right rear wheel, Lᵣ denotes the second distance, vₓ denotes the longitudinal vehicle speed, B_{f} denotes the front track width, and a_{s,rr} denotes the fourth saturation sideslip angle.

In the embodiments of the present disclosure, the vehicle sideslip angle constraint information of the vehicle in the first region is obtained based on the first vehicle sideslip angle constraint information of the left front wheel, the second vehicle sideslip angle constraint information of the right front wheel, the third vehicle sideslip angle constraint information of the left rear wheel, and the fourth vehicle sideslip angle constraint information of the right rear wheel. That is, the vehicle sideslip angle constraint information of the vehicle in the first region can be comprehensively determined based on the vehicle sideslip angle constraint information of the front and rear four wheels, thereby improving the accuracy of the vehicle sideslip angle constraint information, and ensuring the safety and stability of the vehicle during driving.

With continued reference to FIG. 3B, step S3032 includes: obtaining a boundary value of the front wheel steering angle of the vehicle by performing boundary value prediction based on the yaw rate constraint information and the vehicle sideslip angle constraint information.

In step S3032, the boundary value prediction is to predict the maximum front wheel steering angle for the vehicle's stable driving, and the boundary value of the front wheel steering angle is the maximum front wheel steering angle. The boundary value of the front wheel steering angle is obtained by combining and simplifying the yaw rate constraint information and the vehicle sideslip angle constraint information.

For example, the boundary value of the front wheel steering angle may be obtained by the following formula (9):

$${δ}_{f , max} = arc tan ( ( {L}_{f} + {L}_{r} ) μ g {v}_{x}^{- 2} - tan ( {α}_{s , r} ) ) + {α}_{s , f} ; \qquad ( 9 )$$

where, δ_{f,max} denotes the maximum front wheel steering angle, L_{f} denotes the first distance from the center of gravity of the vehicle to the front axle of the vehicle, Lᵣ denotes the second distance from the center of gravity of the vehicle to the rear axle of the vehicle, a_{s,f} denotes the saturation sideslip angle of the front wheels, and a_{s,r} denotes the saturation sideslip angle of the rear wheels.

Step S3033 includes: obtaining the lateral stability constraint information by performing the vehicle state constraint prediction based on the yaw rate constraint information, the vehicle sideslip angle constraint information, and the boundary value of the front wheel steering angle.

In step S3033, the lateral stability boundary of the vehicle is predicted based on the yaw rate constraint information, the vehicle sideslip angle constraint information, and the boundary value of the front wheel steering angle. By combining the yaw rate constraint information, the vehicle sideslip angle constraint information, and the boundary value of the front wheel steering angle, and assuming that the saturation sideslip angles of the front and rear four wheels are equal, the lateral stability constraint information is derived.

For example, the lateral stability constraint information may be obtained by the following formula (10):

$$\{ \begin{matrix}- {λ}_{2} \leq {λ}_{1} γ - β \leq {λ}_{2} \\ - {λ}_{4} \leq γ - {λ}_{3} β \leq {λ}_{4}\end{matrix} ; \qquad ( 10 )$$

where, γ denotes the yaw rate, β denotes the vehicle sideslip angle, λ₁ is expressed as

$${L}_{r} {v}_{x}^{- 1} , {λ}_{2}$$

is expressed as tan(a_{s,r}), λ₃ is expressed as

$${v}_{x} {L}_{r}^{- 1} , and {λ}_{4}$$

is expressed as

$${v}_{x} {L}_{r}^{- 1} tan ( {α}_{s , r} ) .$$

The form of the lateral stability constraint information may be transformed using a system state error formula. For example, the system state error formula may be obtained by the following formula (11):

$$\{ \begin{matrix}{e}_{l} = - ( x - {x}_{d} ) sin {θ}_{d} + ( y - {y}_{d} ) cos {θ}_{d} \\ \dot{{e}_{l}} = {v}_{y} + {v}_{x} {e}_{φ} \\ {e}_{φ} = φ - {θ}_{r} \\ \dot{{e}_{φ}} = \dot{φ} - {k}_{d} {v}_{x} \\ {e}_{s} = ( x - {x}_{d} ) cos {θ}_{d} + ( y - {y}_{d} ) sin {θ}_{d} \\ \dot{{e}_{s}} = {v}_{x} - {v}_{y} {e}_{φ}\end{matrix} ; \qquad ( 11 )$$

where, eₗ denotes a lateral position error, ėₗ denotes a lateral velocity error, e_{φ} denotes a yaw error, ė_{φ} denotes a derivative of the yaw error, eₛ denotes a longitudinal position error, ėₛ denotes a longitudinal velocity error, x denotes a longitudinal position of the vehicle, y denotes a lateral position of the vehicle, θ denotes a yaw angle, x_{d} denotes a longitudinal position of a vehicle matching point, y_{d} denotes a lateral position of the vehicle matching point, θ_{d} denotes a yaw angle of the vehicle matching point, k_{d} denotes a vehicle trajectory curvature, θᵣ denotes a yaw angle of a projection point, v_{y} denotes a lateral vehicle speed, and vₓ denotes a longitudinal vehicle speed.

Based on the lateral error [ėₗ, ė_{φ}, eₗ, e_{φ}]^{T} in the system state error formula and by assuming that the vehicle sideslip angle β≈v_{y}/vₓ, the transformed lateral stability constraint information is obtained. For example, the transformed lateral stability constraint information may be obtained by the following formula (12):

$$\{ \begin{matrix}- {v}_{x} {λ}_{2} \leq {λ}_{1} {v}_{x} γ - \dot{{e}_{l}} + {v}_{x} {e}_{φ} \leq {v}_{x} {λ}_{2} \\ - {v}_{x} {λ}_{4} \leq {v}_{x} γ - {λ}_{3} {\dot{e}}_{l} + {λ}_{3} {v}_{x} {e}_{φ} \leq {v}_{x} {λ}_{4}\end{matrix} . \qquad ( 12 )$$

In the embodiments of the present disclosure, the lateral stability constraint information is obtained by performing the vehicle state constraint prediction based on the yaw rate constraint information, the vehicle sideslip angle constraint information, and the boundary value of the front wheel steering angle, thereby realizing the design of safer lateral stability boundary conditions, and ensuring the safety and stability of the vehicle during driving.

With continued reference to FIG. 3A, step S304 includes: designing a cost function of a model predictive controller of the vehicle, and obtaining a first control quantity through receding horizon control based on the lateral stability constraint information and the cost function.

In step S304, the model predictive controller may be a model predictive controller based on the nominal model. The nominal model is a model used to approximately describe the dynamic behavior of the actual vehicle system, and the model predictive controller is a controller used to optimize the vehicle driving path and enhance vehicle driving stability and accuracy. The cost function of the model predictive controller is a function used to optimize the control input, and may be obtained by the following formula (13):

$$J ( k ) = {\sum }_{i = 1}^{{N}_{p}} {‖ \overline{η} ( k + i ) ‖}_{Q}^{2} + {\sum }_{i = 0}^{{N}_{c} - 1} {‖ Δ \overline{u} ( k + i ) ‖}_{R}^{2} ; \qquad ( 13 )$$

where, J(k) denotes the cost function, Nₚ denotes a prediction horizon, N_{c} denotes a control horizon, η̅(k+i) denotes an output quantity of the vehicle system at the i-th moment, Δū(k+i) denotes a control increment of the front wheel steering angle at the i-th moment, Q denotes a weight coefficient matrix of the state quantity of the model predictive controller, and R denotes a weight coefficient matrix of the control increment of the model predictive controller.

The first control quantity is the optimal control quantity, and the first control quantity is obtained by performing an optimal control quantity prediction based on the lateral stability constraint information and the cost function of the model predictive controller.

FIG. 3E illustrates a fifth schematic flowchart of the vehicle data processing method according to an embodiment of the present disclosure. Step S304 shown in FIG. 3A may be implemented by Steps S3041 to S3043 shown in FIG. 3E. This is described in detail below.

Step S3041 includes: discretizing the lateral stability constraint information to obtain the discrete lateral stability constraint information.

In step S3041, the form of the lateral stability constraint information is transformed using the system state error formula, and the transformed lateral stability constraint information is discretized to obtain the discrete lateral stability constraint information. For example, the discrete lateral stability constraint information may be obtained by the following formula (14):

$$- {I}_{s} ( k ) \leq {V}_{s} ( k ) X ( k ) \leq {I}_{s} ( k ) ; \qquad ( 14 )$$

where, X(k) denotes a discrete vehicle system state quantity, Iₛ(k) is expressed as

$$[ \begin{matrix}{v}_{x} {λ}_{2} \\ {v}_{x} {λ}_{4}\end{matrix} ] ,$$

and Vₛ(k) is expressed as

$$[ \begin{matrix}- 1 & {v}_{x} {λ}_{1} & 0 & {v}_{x} \\ - {λ}_{3} & {v}_{x} & 0 & {v}_{x} {λ}_{3}\end{matrix} ] .$$

Step S3042 includes: obtaining control increment constraint information of the front wheel steering angle, control quantity constraint information of the front wheel steering angle, and vehicle system output quantity constraint information in the model predictive controller.

In step S3042, the control increment constraint information includes: a minimum front wheel steering angle control increment, and a maximum front wheel steering angle control increment. For example, the control increment constraint information may be expressed as Δūₘᵢₙ≤Δūₖ₊ᵢ≤ūₘₐₓ, where Δūₖ₊ᵢ denotes a front wheel steering angle control increment at the i-th moment, Δūₘᵢₙ denotes the minimum front wheel steering angle control increment, and Δūₘₐₓ denotes the maximum front wheel steering angle control increment.

The control quantity constraint information includes: a minimum front wheel steering angle control quantity, and a maximum front wheel steering angle control quantity. For example, the control quantity constraint information may be expressed as Δūₘᵢₙ≤Δūₖ₊ᵢ+ūₖ₊ᵢ≤ūₘₐₓ, where Δūₖ₊ᵢ+ūₖ₊ᵢ denotes a front wheel steering angle control quantity at the i-th moment, ūₘᵢₙ denotes the minimum front wheel steering angle control quantity, and ūₘₐₓ denotes the maximum front wheel steering angle control quantity.

The vehicle system output quantity constraint information includes: a minimum vehicle system output quantity, and a maximum vehicle system output quantity. For example, the vehicle system output quantity constraint information may be expressed as η̅ₘᵢₙ≤η̅ₖ≤η̅ₘₐₓ, where η̅ₖ denotes a vehicle system output quantity, η̅ₘᵢₙ denotes the minimum vehicle system output quantity, and η̅ₘₐₓ denotes the maximum vehicle system output quantity.

Step S3043 includes: calculating a minimum constraint value of the cost function based on the discrete lateral stability constraint information, the control increment constraint information, the control quantity constraint information, and the vehicle system output quantity constraint information, and obtaining a control quantity of the front wheel steering angle corresponding to the minimum constraint value as the first control quantity.

In step S3043, an input state vector of the vehicle system is obtained, and an updated input state vector is obtained by adding the front wheel steering angle control quantity to the input state vector. Based on the discrete lateral stability constraint information, the control increment constraint information, the control quantity constraint information, the vehicle system output quantity constraint information, and the updated input state vector, a constraint-based design is performed on the cost function to obtain a cost constraint function. For example, the cost constraint function may be obtained by the following formula (15):

$$\{ \begin{matrix}min J ( \overline{{ξ}_{k}} , Δ {\overline{u}}_{k} ) \\ - {I}_{s} ( k ) \leq {V}_{s} ( k ) \overline{X} ( k ) \leq {I}_{s} ( k ) \\ \begin{matrix}Δ {\overline{u}}_{min} \leq Δ {\overline{u}}_{k + i} \leq {\overline{u}}_{max} & i = 0 , 1 , … , {N}_{c} - 1\end{matrix} \\ \begin{matrix}{\overline{u}}_{min} \leq Δ {\overline{u}}_{k + i} + {\overline{u}}_{k + i} \leq {\overline{u}}_{max} & i = 0 , 1 , … , {N}_{c} - 1\end{matrix} \\ {\overline{η}}_{min} \leq Δ {\overline{η}}_{k} \leq {\overline{η}}_{max}\end{matrix} ; \qquad ( 15 )$$

where, ξ̅ₖ is expressed as

$$[ \begin{matrix}{ξ}_{k} \\ {u}_{k - 1}\end{matrix} ] ,$$

ξₖ denotes the updated input state vector, ξₖ denotes the input state vector of the vehicle system, uₖ₋₁ denotes the front wheel steering angle control quantity at the previous moment, Δūₘᵢₙ denotes the minimum front wheel steering angle control increment, Δūₘₐₓ denotes the maximum front wheel steering angle control increment, ūₘᵢₙ denotes the minimum front wheel steering angle control quantity, ūₘₐₓ denotes the maximum front wheel steering angle control quantity, η̅ₘᵢₙ denotes the minimum vehicle system output quantity, η̅ₘₐₓ denotes the maximum vehicle system output quantity, and N_{c} denotes the control horizon.

A minimum cost value of the cost function, that is, the minimum constraint value, is obtained subject to the cost constraint function, and the control quantity of the front wheel steering angle corresponding to the minimum constraint value is obtained as the optimal control quantity, that is, the first control quantity.

In the embodiments of the present disclosure, the first control quantity is obtained by performing the control quantity prediction based on the lateral stability constraint information and the cost function, thereby realizing the trajectory tracking by the model predictive controller under the improved lateral stability constraint state, and improving the trajectory tracking accuracy of the vehicle.

With continued reference to FIG. 3A, step S305 includes: obtaining a feedback compensation control quantity of the vehicle, obtaining a second control quantity based on the first control quantity and the feedback compensation control quantity, and controlling the vehicle to perform closed-loop trajectory tracking based on the second control quantity and a reference trajectory.

In step S305, the feedback compensation control quantity is obtained by using a Proportion Integration Differentiation (PID) feedback controller based on the error between the model state quantity output by the model predictive controller and the actual vehicle state quantity. The actual vehicle control quantity, that is, the second control quantity, is obtained by summing the first control quantity and the feedback compensation control quantity. The model predictive controller controls the vehicle to perform trajectory tracking based on the second control quantity and the reference trajectory. For example, the second control quantity may be obtained by the following formula (16):

$$u ( k ) = {\overline{u}}^{*} ( k ) + {u}_{pid} ( k ) ; \qquad ( 16 )$$

where, u(k) denotes the second control quantity, ū*(k) denotes the first control quantity, and u_{pid}(k) denotes the feedback compensation control quantity.

In some embodiments, obtaining the feedback compensation control quantity of the vehicle may include: obtaining a first vehicle state quantity corresponding to the minimum constraint value and a second vehicle state quantity corresponding to the actual state of the vehicle, wherein the first vehicle state quantity includes a first position and a first yaw angle of the center of gravity of the vehicle, and the second vehicle state quantity includes a second position and a second yaw angle of the center of gravity of the vehicle; obtaining a distance error between the first position and the second position and an angle error between the first yaw angle and the second yaw angle; performing a weighting processing on the angle error based on a preset weight coefficient to obtain a weighted angle error, and obtaining a control error based on the weighted angle error and the distance error; and obtaining the feedback compensation control quantity of the vehicle by adjusting the control error based on a preset proportional coefficient, a preset integral coefficient, a preset derivative coefficient and a preset sampling interval. Optionally, in one embodiment of the present disclosure, a sum of the weighted angle error and the distance error is obtained as the control error.

The vehicle state quantity corresponding to the minimum constraint value of the cost function of the model predictive controller is obtained as the optimal vehicle state quantity, that is, the first vehicle state quantity. The first vehicle state quantity includes: an optimal position and an optimal yaw angle of the center of gravity of the vehicle, that is, the first position and the first yaw angle of the center of gravity of the vehicle. The second vehicle state quantity is the actual vehicle state quantity, and the second vehicle state quantity includes: an actual position and an actual yaw angle of the center of gravity of the vehicle, that is, the second position and the second yaw angle of the center of gravity of the vehicle.

The first position includes: a first lateral position and a first longitudinal position of the center of gravity of the vehicle, and the second position includes: a second lateral position and a second longitudinal position of the center of gravity of the vehicle. A longitudinal position difference is obtained by subtracting the second longitudinal position from the first longitudinal position, and a longitudinal position error is obtained by multiplying the longitudinal position difference by the sine of the first yaw angle. A lateral position difference is obtained by subtracting the second lateral position from the first lateral position, and a lateral position error is obtained by multiplying the lateral position difference by the cosine of the first yaw angle. A distance error is obtained as the difference between the lateral position error and the longitudinal position error. An angle error is obtained by subtracting the second yaw angle from the first yaw angle. For example, the distance error and the angle error may be obtained by the following formula (17):

$$\{ \begin{matrix}{e}_{d} = - ( x - \overline{x} ) sin \overline{θ} + ( y - \overline{y} ) cos \overline{θ} \\ {e}_{θ} = θ - \overline{θ}\end{matrix} ; \qquad ( 17 )$$

where, e_{d} denotes the distance error, e_{θ} denotes the angle error, x̅ denotes the first longitudinal position, y̅ denotes the first lateral position, x denotes the second longitudinal position, y denotes the second lateral position, θ̅ denotes the first yaw angle, and θ denotes the second yaw angle.

The control error of the PID feedback controller is obtained by summing the angle error weighted based on the preset weight coefficient and the distance error. For example, the control error may be obtained by the following formula:

$$e ( k ) = {e}_{d} ( k ) + λ {e}_{θ} ( k ) ; \qquad ( 18 )$$

where, e(k) denotes the control error, λ denotes the preset weight coefficient, e_{d}(k) denotes the distance error, and e_{θ}(k) denotes the angle error.

A first compensation control quantity is obtained by multiplying the preset proportional coefficient of the PID feedback controller by the control error. A second compensation control quantity is obtained by multiplying the preset integral coefficient of the PID feedback controller by a cumulative sum of the control error. A feedback compensation control quantity is obtained by dividing a product of the preset derivative coefficient of the PID feedback controller and a increment of the control error by the preset sampling interval. For example, the feedback compensation control quantity may be obtained by the following formula (19):

$${u}_{pid} ( k ) = {k}_{p} e ( k ) + {k}_{i} {\sum }_{k = 1}^{j} e ( k ) + {k}_{d} ( e ( k ) - e ( k - 1 ) ) / T ; \qquad ( 19 )$$

where, u_{pid} denotes the feedback compensation control quantity, kₚ denotes the preset proportional coefficient, kᵢ denotes the preset integral coefficient, k_{d} denotes the preset derivative coefficient, e(k) denotes the control error,

$${\sum }_{k = 1}^{j} e ( k )$$

denotes the cumulative sum of the control error, and e(k)−e(k−1) denotes the increment of the control error.

In the embodiments of the present disclosure, as the feedback compensation control quantity of the vehicle is obtained by adjusting the control error based on the preset proportional coefficient, the preset integral coefficient, the preset derivative coefficient and the preset sampling interval of the PID feedback controller, the deviations in vehicle trajectory tracking can be compensated for, and the trajectory tracking accuracy of the vehicle is improved.

In some embodiments, the vehicle data processing method provided in the present disclosure may be applied to the field of unmanned driving technology. An unmanned driving terminal server obtains the yaw rate and the vehicle sideslip angle of the vehicle during driving, constructs the phase plane diagram based on the yaw rate and the vehicle sideslip angle, identifies the first region in the phase plane diagram by performing the dynamic stability analysis of the vehicle based on the phase plane diagram, and obtains the lateral stability constraint information by performing the vehicle state constraint prediction based on the first region, so as to realize the phase plane method analysis using lateral stability-related parameters, and to design safer lateral stability boundary conditions for the model predictive controller, thereby ensuring the safety and stability of the vehicle during driving. The unmanned driving terminal server further obtains the cost function of the model predictive controller of the vehicle, obtains the first control quantity by performing the control quantity prediction based on the lateral stability constraint information and the cost function, obtains the feedback compensation control quantity of the vehicle, obtains the second control quantity by summing the first control quantity and the feedback compensation control quantity, and controls the vehicle to perform trajectory tracking based on the second control quantity and the reference trajectory. Thus, the vehicle trajectory tracking by the model predictive controller under the improved lateral stability constraint state is realized. Furthermore, since the feedback compensation control quantity is introduced, the deviations in vehicle trajectory tracking can be compensated for, and the trajectory tracking accuracy of the vehicle is improved.

Next, an exemplary application of the vehicle data processing method provided in the embodiments of the present disclosure in the scenario of trajectory tracking for autonomous vehicles will be described.

In the related art, the model predictive control method is a traditional method in the field of trajectory tracking for autonomous vehicles. This method predicts a vehicle state using a vehicle model within a limited prediction horizon, and calculates the optimal control input by solving an optimization problem, thereby enabling the vehicle to track the desired trajectory, handling the constraint conditions and nonlinear characteristics of multi-input multi-output systems, and providing a flexible and efficient control strategy.

When a vehicle is under extreme working conditions, for example, during high-speed traveling, the magnitude of oscillations in the front wheel steering angle affects the yaw stability of the vehicle. For the safety of the vehicle during high-speed traveling, it is necessary to accurately evaluate the lateral stability constraint conditions of the vehicle to ensure the safety and stability of the vehicle under various complex environments. In addition, since in the application of the model predictive controller, the vehicle model for constructing the optimization problem has uncertainties, such as changes in vehicle parameters, external disturbances and errors in modeling parameters, the final optimized control result will result in errors in the trajectory tracking of the vehicle, thereby seriously affecting the trajectory tracking accuracy of the vehicle.

Aiming at the problems existing in the related art, the embodiments of the present disclosure provide a vehicle data processing method, which includes the following improvements compared with the related art:

The method obtains the lateral stability constraint conditions of the vehicle under extreme working conditions by using the phase plane method of vehicle sideslip angle-yaw rate. The method further constructs a composite control system combining a nominal model predictive controller and a Proportion Integration Differentiation (PID) feedback controller to perform convergence control on the deviation between the predicted state of the nominal model predictive controller and the actual vehicle state, thereby realizing the trajectory tracking for autonomous vehicles under the improved lateral stability constraint state by the nominal model predictive controller, as well as the dynamic adjustment of the control input. The method further guides the vehicle to travel along a predetermined trajectory by using the generated optimal control input, and introduces the PID feedback controller to compensate for the deviation between the actual vehicle model and the nominal model and eliminate the steady-state error of vehicle trajectory tracking, thereby improving the trajectory tracking accuracy of the vehicle.

The input of the vehicle trajectory tracking controller includes: a reference trajectory from the upstream planning module, and a current actual vehicle state quantity of the vehicle. The trajectory tracking control can be realized by the nominal model predictive controller based on the PID feedback controller. For example, FIG. 4 illustrates a schematic flowchart of the vehicle data processing method according to an embodiment of the present disclosure. The following will explain and describe the vehicle data processing flow provided in the embodiments of the present disclosure in combination with FIG. 4.

First, the nominal model predictive controller is designed. The nominal model predictive controller 401 includes: a state estimation module 402, a stability constraint module 403, a cost function calculation module 404, and an actual vehicle model module 405. The input of the nominal model predictive controller 401 is the reference trajectory, and the output of the nominal model predictive controller 401 is a nominal model control quantity (i.e., the first control quantity in the above-mentioned embodiments). A nominal model state quantity (i.e., the first vehicle state quantity in the above-mentioned embodiments) is obtained by using the nominal model control quantity to control a nominal vehicle model (i.e., the nominal model in the above-mentioned embodiments). The difference between the nominal model state quantity and the actual vehicle state quantity (i.e., the second vehicle state quantity in the above-mentioned embodiments) is taken as the state error (i.e., the distance error and the angle error in the above-mentioned embodiments), and the state error is input into the PID feedback controller 406, and the output of the PID feedback controller 406 is a feedback control quantity. The feedback control quantity and the nominal model control quantity are summed to obtain a composite control quantity (i.e., the second control quantity in the above-mentioned embodiments), and the composite control quantity is the actual vehicle control quantity. This enables the nominal model predictive controller to solve for the optimal control quantity based on the reference trajectory and the nominal model state quantity.

In the state estimation module 402, the lateral stability constraint conditions of the vehicle are obtained based on the lateral stability-related state quantities of the autonomous vehicle. In the vehicle system, the vehicle sideslip angle is a physical parameter that can describe the deviation degree of vehicle trajectory tracking. When the vehicle sideslip angle is small, the magnitude of the yaw rate determines the turning ability of the vehicle. Therefore, the stability and turning performance of the vehicle are characterized by the vehicle sideslip angle and the yaw rate. Considering that the yaw rate and lateral acceleration of the vehicle can be directly observed by sensors, while the vehicle sideslip angle is a difficult-to-observe physical quantity, it is necessary to design a state estimator to observe the vehicle sideslip angle. For example, the vehicle sideslip angle may be obtained by the following formula (1):

$$β = arctan ( {v}_{y} / {v}_{x} ) ; \qquad ( 1 )$$

where, β denotes the vehicle sideslip angle, v_{y} denotes the lateral vehicle speed, and vₓ denotes the longitudinal vehicle speed.

An Extended Kalman Filter (EKF) method may be used to observe the vehicle sideslip angle. Specifically, the differential equations of the lateral and yaw motions of the vehicle system can be obtained according to the vehicle dynamics model, and the differential equations of the vehicle sideslip angle and the yaw rate can be obtained by simplifying the differential equations of the lateral and yaw motions of the vehicle system. For example, the differential equations of the vehicle sideslip angle and the yaw rate may be obtained by the following formula (2):

$$\{ \begin{matrix}\dot{β} = \frac{2 {F}_{lf} sin {δ}_{f} + 2 {F}_{cf} cos {δ}_{f} + 2 {F}_{cr}}{{mv}_{x}} - γ \\ \dot{γ} = \frac{2 {L}_{f} ( {F}_{lf} sin {δ}_{f} + {F}_{cf} cos {δ}_{f} ) - 2 {L}_{r} {F}_{cr}}{{I}_{z}}\end{matrix} ; \qquad ( 2 )$$

where, \dot{β} denotes the differential of the vehicle sideslip angle, \dot{γ} denotes the differential of the yaw rate, δ_{f} denotes the front wheel steering angle, m denotes the vehicle mass, F_{lf} denotes the longitudinal force on the front wheels, F_{cf} denotes the lateral force on the front wheels, F_{cr} denotes the lateral force on the rear wheels, I_{z} denotes the moment of inertia, L_{f} denotes the distance from the center of gravity of the vehicle to the front axle of the vehicle, and Lᵣ denotes the distance from the center of gravity of the vehicle to the rear axle of the vehicle.

The yaw rate and the lateral acceleration can be directly observed by sensors. For example, the lateral acceleration may be obtained by the following formula (3):

$${a}_{y} = \frac{2 {F}_{lf} sin {δ}_{f} + 2 {F}_{cf} cos {δ}_{f} + 2 {F}_{cr}}{m} ; \qquad ( 3 )$$

where, a_{y} denotes the lateral acceleration, δ_{f} denotes the front wheel steering angle, m denotes the vehicle mass, F_{lf} denotes the longitudinal force on the front wheels, F_{cf} denotes the lateral force on the front wheels, and F_{cr} denotes the lateral force on the rear wheels.

The vehicle sideslip angle can characterize the extent of lateral slip of the vehicle. A large vehicle sideslip angle indicates that the vehicle has a significant extent of lateral slip, which will lead to difficult vehicle handling. Thus, the limit value of the vehicle sideslip angle determines the maximum lateral deviation angle for safe vehicle handling. For example, with continued reference to FIG. 4, the dynamic stability analysis of the vehicle is performed in the stability constraint module 403. The dynamic trajectory formed by the variation of vehicle state parameters can be observed by constructing the vehicle sideslip angle-yaw rate phase plane diagram. The lateral force of the tires increases when a steering maneuver is performed while the vehicle is traveling, and when the steering angle exceeds a threshold value, the lateral force of the tires will enter a nonlinear saturation region, at which point the vehicle is highly prone to an instability phenomenon. When the lateral force on the vehicle's front wheels reaches the saturated state, the vehicle may lose its steering capability, thus failing to track the predetermined trajectory. When the lateral force on the vehicle's rear wheels is saturated, the vehicle is likely to exhibit unstable behaviors such as spinout.

The lateral and yaw motion system of the vehicle is a second-order dynamic system. The stable region and the unstable region of the vehicle during driving are analyzed and obtained by observing the equilibrium point of the vehicle on the phase plane and the phase trajectories that change with the variation of the vehicle state variables. Specifically, differential equations for describing the lateral and yaw motions of the vehicle are established based on vehicle dynamics principles. By using the vehicle state variables that change with time, the differential equations are solved, and the phase trajectories of the vehicle under different vehicle state variables are plotted. In the phase plane, it is first necessary to obtain the equilibrium point of the system, i.e., the stable state of the vehicle in the absence of external disturbances. The equilibrium point usually corresponds to a zero vehicle sideslip angle and a zero yaw rate, representing that the vehicle travels straight without yawing. If the phase trajectories converge toward the equilibrium point, this indicates that the vehicle is in a stable state, and the region occupied by the phase trajectories is the stable region. If the phase trajectories diverge from the equilibrium point, this indicates that the vehicle is in an unstable state, and the region occupied by the phase trajectories is the unstable region.

The state constraint for the vehicle system is performed based on the stable region, and the lateral stability boundary of the vehicle is designed. Assuming that the longitudinal vehicle speed and the road adhesion coefficient remain constant, the yaw rate boundary of the vehicle in the stable region is obtained based on the longitudinal vehicle speed and the road adhesion coefficient. For example, the yaw rate boundary may be obtained by the following formula (4):

$$\{ \begin{matrix}{γ}_{max} = μ {gv}_{x}^{- 1} \\ {γ}_{min} = - μ {gv}_{x}^{- 1}\end{matrix} ; \qquad ( 4 )$$

where, γₘₐₓ denotes the maximum yaw rate, γₘᵢₙ denotes the minimum yaw rate, μ denotes the road adhesion coefficient, vₓ denotes the longitudinal vehicle speed, and g denotes the gravitational acceleration.

The vehicle sideslip angle boundaries for the front wheels and the rear wheels of the vehicle within the stable region are obtained. For example, the vehicle sideslip angle boundary for the left front wheel may be obtained by the following formula (5):

$$\{ \begin{matrix}{β}_{{α}_{lf , max}} = - ( {L}_{f} {v}_{x}^{- 1} + 1 / 2 {v}_{x}^{- 1} {B}_{r} tan ( {δ}_{f} + {α}_{s , lf} ) ) γ + tan ( {δ}_{f} + {α}_{s , lf} ) \\ {β}_{{α}_{lf , min}} = - ( {L}_{f} {v}_{x}^{- 1} + 1 / 2 {v}_{x}^{- 1} {B}_{r} tan ( {δ}_{f} - {α}_{s , lf} ) ) γ + tan ( {δ}_{f} - {α}_{s , lf} )\end{matrix} ; \qquad ( 5 )$$

where, βₐ_{_{lf,max}} denotes the maximum vehicle sideslip angle of the left front wheel, βₐ_{_{lf,min}} a denotes the minimum vehicle sideslip angle of the left front wheel, L_{f} denotes the distance from the center of gravity of the vehicle to the front axle of the vehicle, vₓ denotes the longitudinal vehicle speed, Bᵣ denotes the rear track width, δ_{f} denotes the front wheel steering angle, γ denotes the yaw rate, and a_{s,lf} denotes the saturation sideslip angle of the left front wheel.

For example, the vehicle sideslip angle boundary for the right front wheel may be obtained by the following formula (6):

$$\{ \begin{matrix}{β}_{{α}_{rf , max}} = - ( {L}_{f} {v}_{x}^{- 1} - 1 / 2 {v}_{x}^{- 1} {B}_{r} tan ( {δ}_{f} + {α}_{s , rf} ) ) γ + tan ( {δ}_{f} + {α}_{srf} ) \\ {β}_{{α}_{rf , min}} = - ( {L}_{f} {v}_{x}^{- 1} - 1 / 2 {v}_{x}^{- 1} {B}_{r} tan ( {δ}_{f} - {α}_{s , rf} ) ) γ + tan ( {δ}_{f} - {α}_{s , rf} )\end{matrix} ; \qquad ( 6 )$$

where, βₐ_{_{rf,max}} a denotes the maximum vehicle sideslip angle of the right front wheel, βₐ_{_{rf,min}} denotes the minimum vehicle sideslip angle of the right front wheel, and a_{s,rf} denotes the saturation sideslip angle of the right front wheel.

For example, the vehicle sideslip angle boundary for the left rear wheel may be obtained by the following formula (7):

$$\{ \begin{matrix}{β}_{α {l}_{r , max}} = - ( {L}_{r} {v}_{x}^{- 1} - 1 / 2 {v}_{x}^{- 1} {B}_{f} tan ( {α}_{s , lr} ) ) γ + tan ( {α}_{s , lr} ) \\ {β}_{α {l}_{r , min}} = - ( {L}_{r} {v}_{x}^{- 1} - 1 / 2 {v}_{x}^{- 1} {B}_{r} tan ( {α}_{s , lr} ) ) γ - tan ( {α}_{s , lr} )\end{matrix} ; \qquad ( 7 )$$

where, βₐₗ_{_{r,max}} denotes the maximum vehicle sideslip angle of the left rear wheel, βₐₗ_{_{r,min}} denotes the minimum vehicle sideslip angle of the left rear wheel, Lᵣ denotes the distance from the center of gravity of the vehicle to the rear axle of the vehicle, B_{f} denotes the front track width, and a_{s,lr} denotes the saturation sideslip angle of the left rear wheel.

For example, the vehicle sideslip angle boundary for the right rear wheel may be obtained by the following formula (8):

$$\{ \begin{matrix}{β}_{{α}_{rr , max}} = - ( {L}_{r} {v}_{x}^{- 1} + 1 / 2 {v}_{x}^{- 1} {B}_{f} tan ( {α}_{s , rr} ) ) γ + tan ( {α}_{s , rr} ) \\ {β}_{{α}_{rr , min}} = - ( {L}_{r} {v}_{x}^{- 1} + 1 / 2 {v}_{x}^{- 1} {B}_{f} tan ( {α}_{s , rr} ) ) γ - tan ( {α}_{s , rr} )\end{matrix} ; \qquad ( 8 )$$

where, βₐ_{_{rr,max}} denotes the maximum vehicle sideslip angle of the right rear wheel, βₐ_{_{rr,min}} denotes the minimum vehicle sideslip angle of the right rear wheel, and a_{s,rr} denotes the saturation sideslip angle of the right rear wheel.

Based on the yaw rate boundary, the vehicle sideslip angle boundaries of the front wheels and the vehicle sideslip angle boundaries of the rear wheels, the boundary prediction of the maximum steady-state front wheel steering angle is performed. Formula (4) to formula (8) are simultaneously solved and subjected to simplification processing, and the boundary value of the front wheel steering angle is obtained. For example, the boundary value of the front wheel steering angle may be obtained by the following formula (9):

$${δ}_{f , max} = arctan ( ( {L}_{f} + {L}_{r} ) {μgv}_{x}^{- 2} - tan ( {α}_{s , r} ) ) + {α}_{s , f} ; \qquad ( 9 )$$

where, δ_{f,max} denotes the maximum front wheel steering angle, L_{f} denotes the distance from the center of gravity of the vehicle to the front axle of the vehicle, Lᵣ denotes the distance from the center of gravity of the vehicle to the rear axle of the vehicle, a_{s,f} denotes the saturation sideslip angle of the front wheels, and a_{s,r} denotes the saturation sideslip angle of the rear wheels.

Based on the yaw rate boundary, the vehicle sideslip angle boundaries of the front and rear wheels and the boundary of the maximum steady-state front wheel steering angle, the state constraint of the vehicle system is performed, and the lateral stability boundary of the vehicle during driving is designed to ensure the lateral stability of the vehicle during driving. Formula (4) to formula (9) are simultaneously solved, and on the assumption that the saturation sideslip angles of the four front and rear wheels are equal, a simplification processing is performed to obtain the lateral stability boundary. For example, the lateral stability boundary may be obtained by the following formula (10):

$$\{ \begin{matrix}- {λ}_{2} \leq {λ}_{1} γ - β \leq {λ}_{2} \\ - {λ}_{4} \leq γ - {λ}_{3} β \leq {λ}_{4}\end{matrix} ; \qquad ( 10 )$$

where, γ denotes the yaw rate, β denotes the vehicle sideslip angle, the expression of λ₁ is

$${L}_{r} {v}_{x}^{- 1} ,$$

the expression of λ₂ is tan(a_{s,r}), the expression of λ₃ is

$${v}_{x} {L}_{r}^{- 1} ,$$

and the expression of λ₄ is

$${v}_{x} {L}_{r}^{- 1} tan ( {α}_{s , r} ) .$$

The form of the lateral stability boundary can be transformed using the system state error formula. For example, the system state error formula may be obtained by the following formula (11):

$$\{ \begin{matrix}{e}_{l} = - ( x - {x}_{d} ) sin {θ}_{d} + ( y - {y}_{d} ) cos {θ}_{d} \\ {\dot{e}}_{l} = {v}_{y} + {v}_{x} {e}_{φ} \\ {e}_{φ} = φ - {θ}_{r} \\ {\dot{e}}_{φ} = \dot{φ} - {k}_{d} {v}_{x} \\ {e}_{s} = ( x - {x}_{d} ) cos {θ}_{d} + ( y - {y}_{d} ) sin {θ}_{d} \\ \dot{e} s = {v}_{x} - {v}_{y} {e}_{φ}\end{matrix} ; \qquad ( 11 )$$

where, eₗ denotes the lateral position error, ėₗ denotes the lateral velocity error, e_{φ} denotes the yaw error, ė_{φ} denotes the derivative of the yaw angle error, eₛ denotes the longitudinal position error, ėₛ denotes the longitudinal velocity error, x denotes the longitudinal position of the vehicle, y denotes the lateral position of the vehicle, θ denotes the yaw angle, x_{d} denotes the longitudinal position of the vehicle matching point, y_{d} denotes the lateral position of the vehicle matching point, θ_{d} denotes the yaw angle of the vehicle matching point, k_{d} denotes the trajectory curvature of the vehicle, and θᵣ denotes the yaw angle of the projection point.

Based on the lateral error [ėₗ, ė_{φ}, eₗ, e_{φ}]^{T} in the system state error formula and by assuming that the vehicle sideslip angle, β≈v_{y}/vₓ the transformed lateral stability boundary is obtained. For example, the transformed lateral stability boundary may be obtained by the following formula (12):

$$\{ \begin{matrix}- {v}_{x} {λ}_{2} \leq {λ}_{1} {v}_{x} γ - {\dot{e}}_{l} + {v}_{x} {e}_{φ} \leq {v}_{x} {λ}_{2} \\ - {v}_{x} {λ}_{4} \leq {v}_{x} γ - {λ}_{3} {\dot{e}}_{l} + {λ}_{3} {v}_{x} {e}_{φ} \leq {v}_{x} {λ}_{4}\end{matrix} ; \qquad ( 12 )$$

The transformed lateral stability boundary is discretized to obtain the discrete lateral stability boundary. For example, the discrete lateral stability boundary may be obtained by the following formula (14):

$$- {I}_{s} ( k ) \leq {V}_{s} ( k ) X ( k ) \leq {I}_{s} ( k ) ; \qquad ( 14 )$$

where, X(k) denotes the discrete vehicle system state quantity, the expression of Iₛ(k) is

$$[ \begin{matrix}{v}_{x} {λ}_{2} \\ {v}_{x} {λ}_{4}\end{matrix} ] ,$$

and the expression of Vₛ(k) is

$$[ \begin{matrix}- 1 & {v}_{x} {λ}_{1} & 0 & {v}_{x} \\ - {λ}_{3} & {v}_{x} & 0 & {v}_{x} {λ}_{3}\end{matrix} ] .$$

In the embodiments of the present disclosure, the lateral stability boundary is designed in the nominal model predictive controller to realize the constraint on the control quantity and the state quantity in the lateral controller, thereby ensuring the lateral stability of the vehicle during driving.

With continued reference to FIG. 4, in the cost function calculation module 404, the cost function of the nominal model predictive controller is designed. For example, the cost function may be obtained by the following formula (13):

$$J ( k ) = {\sum }_{i = 1}^{{N}_{p}} {‖ \overline{η} ( k + i ) ‖}_{Q}^{2} + {\sum }_{i = 0}^{{N}_{c} - 1} {‖ Δ \overline{u} ( k + i ) ‖}_{R}^{2} ; \qquad ( 13 )$$

where, J(k) denotes the cost function, Nₚ denotes the prediction horizon, N_{c} denotes the control horizon, η̅(k+i) denotes the output quantity of the vehicle system at the i-th moment, Δη̅(k+i) denotes the control increment of the front wheel steering angle at the i-th moment, Q denotes the weight coefficient matrix of the state quantity of the model predictive controller, and R denotes the weight coefficient matrix of the control increment of the model predictive controller.

Based on the discrete lateral stability boundary, a constraint-based design is performed for the cost function in the nominal model predictive controller to obtain the cost constraint function, and the cost constraint function is solved to obtain the optimal control quantity. For example, the cost constraint function may be obtained by the following formula (15):

$$\{ \begin{matrix}min J ( {\overline{ξ}}_{k} , Δ {\overline{u}}_{k} ) \\ - {I}_{s} ( k ) \leq {V}_{s} ( k ) \overline{X} ( k ) \leq {I}_{s} ( k ) \\ Δ {\overline{u}}_{min} \leq Δ {\overline{u}}_{k + i} \leq Δ {\overline{u}}_{max} i = 0 , 1 , … , {N}_{c} - 1 \\ {\overline{u}}_{min} \leq Δ {\overline{u}}_{k + i} + {\overline{u}}_{k + i} \leq {\overline{u}}_{max} i = 0 , 1 , … , {N}_{c} - 1 \\ {\overline{η}}_{min} \leq {\overline{η}}_{k} \leq {\overline{η}}_{max}\end{matrix} ; \qquad ( 15 )$$

where, the expression ξ̅ₖ is

$$[ \begin{matrix}{ξ}_{k} \\ {u}_{k - 1}\end{matrix} ] ,$$

ξ̅ₖ denotes the updated input state vector, ξₖ denotes the input state vector of the vehicle system, uₖ₋₁ denotes the front wheel steering angle control quantity at the previous moment, Δūₘᵢₙ denotes the minimum front wheel steering angle control increment, Δūₘₐₓ denotes the maximum front wheel steering angle control increment, ūₘᵢₙ denotes the minimum front wheel steering angle control quantity, ūₘₐₓ denotes the maximum front wheel steering angle control quantity, η̅ₘᵢₙ denotes the minimum vehicle system output quantity, η̅ₘₐₓ denotes the maximum vehicle system output quantity.

To achieve the lateral control of the vehicle, the PID feedback controller is designed based on the nominal model state quantity and the actual vehicle state quantity to perform state feedback control on the external disturbance of the vehicle system and the error of the nominal model predictive controller. For example, the control error of the PID feedback controller may be obtained by the following formula (18):

$$e ( k ) = {e}_{d} ( k ) + {λ e}_{θ} ( k ) . \qquad ( 18 )$$

Wherein, e denotes the control error, λ denotes the weight coefficient, and the expressions of e_{d} and e_{θ} are shown in the following formula (17):

$$\{ \begin{matrix}{e}_{d} = - ( x - \overline{x} ) sin \overline{θ} + ( y - y ) cos \overline{θ} \\ {e}_{θ} = θ - \overline{θ}\end{matrix} ; \qquad ( 17 )$$

where, the expression of the nominal model state quantity is [\hat{x}, y̅, θ̅]^{T}, x̅ denotes the longitudinal position of the vehicle predicted by the nominal model, y̅ denotes the lateral position of the vehicle predicted by the nominal model, θ̅ denotes the yaw angle predicted by the nominal model, the expression of the actual vehicle state quantity is [x,y,θ]^{T}, x denotes the actual longitudinal position of the vehicle, y denotes the actual lateral position of the vehicle, and θ denotes the actual yaw angle.

The formula for the feedback compensation control quantity of the PID feedback controller is designed. For example, the formula for the feedback compensation control quantity may be obtained by the following formula (19):

$${u}_{pid} ( k ) = {k}_{p} e ( k ) + {k}_{i} {\sum }_{k = 1}^{j} e ( k ) + {k}_{d} ( e ( k ) - e ( k - 1 ) ) / T ; \qquad ( 19 )$$

where, u_{pid} denotes the feedback compensation control quantity, kₚ denotes the proportional coefficient of the PID feedback controller, kᵢ denotes the integral coefficient of the PID feedback controller, and k_{d} denotes the derivative coefficient of the PID feedback controller.

Finally, the actual vehicle control quantity is obtained by summing the optimal control quantity and the feedback compensation control quantity. For example, the actual vehicle control quantity may be obtained by the following formula (16):

$$u ( k ) = {\overline{u}}^{*} ( k ) + {u}_{p i d} ( k ) ; \qquad ( 16 )$$

where, u denotes the actual vehicle control quantity, ū* denotes the optimal control quantity, and u_{pid} denotes the feedback compensation control quantity.

With continued reference to FIG. 4, in the actual vehicle model module 405, the actual vehicle control quantity and the reference trajectory are used to perform the trajectory tracking for the autonomous vehicle.

In the above-mentioned application scenario of the trajectory tracking for the autonomous vehicle, the safer lateral stability boundary conditions for the model predictive controller are designed, by considering the lateral stability constraint conditions of the vehicle under extreme working conditions, estimating the difficult-to-obtain state quantities of the vehicle using the EKF method, and performing the analysis of the phase plane method based on the lateral stability-related parameters. The composite control system combining the nominal model predictive controller and the PID feedback controller effectively eliminates the steady-state error between the nominal vehicle model and the actual vehicle model, thereby improving the trajectory tracking accuracy of the autonomous vehicle.

Next, an exemplary structure of the vehicle data processing device 455 provided in the embodiments of the present disclosure implemented as software modules is further described. In some embodiments, as shown in FIG. 3, the software modules stored in the vehicle data processing device 455 in the memory 450 may include: a first determination module 4551, used to obtain a yaw rate and a vehicle sideslip angle of the vehicle during driving, and construct a phase plane diagram configured to characterize lateral vehicle dynamics state based on the yaw rate and the vehicle sideslip angle; a data analysis module 4552, used to identifying a first region in the phase plane diagram by performing dynamic stability analysis of the vehicle on the phase plane diagram; a first prediction module 4553, used to predict lateral stability constraint information of the vehicle state within a preset horizon based on boundary characteristics of the first region; a second prediction module 4554, used to obtain a cost function of a model predictive controller of the vehicle, and obtain a first control quantity through receding horizon control based on the lateral stability constraint information and the cost function; a second determination module 4555, used to obtain a feedback compensation control quantity of the vehicle, obtain a second control quantity based on the first control quantity and the feedback compensation control quantity, and control the vehicle to perform closed-loop trajectory tracking based on the second control quantity and a reference trajectory.

In some embodiments, the data analysis module 4552 is further used to: obtain an equilibrium point and N phase trajectories of the vehicle in the phase plane diagram, wherein N is a positive integer; select at least one target phase trajectory converging to the equilibrium point from the N phase trajectories; and identify the region occupied by the at least one target phase trajectory in the phase plane diagram as the first region.

In some embodiments, the first prediction module 4553 is further used to: obtain the yaw rate constraint information and the vehicle sideslip angle constraint information of the vehicle in the first region; perform the boundary value prediction based on the yaw rate constraint information and the vehicle sideslip angle constraint information to obtain the boundary value of the front wheel steering angle of the vehicle; and perform the vehicle state constraint prediction based on the yaw rate constraint information, the vehicle sideslip angle constraint information and the boundary value of the front wheel steering angle to obtain the lateral stability constraint information.

In some embodiments, the yaw rate constraint information includes the minimum yaw rate and the maximum yaw rate. The first prediction module 4553 is further used to: obtain the longitudinal vehicle speed and the road adhesion coefficient of the vehicle in the first region; obtain the maximum yaw rate based on the longitudinal vehicle speed, the road adhesion coefficient and the gravitational acceleration; and obtain the minimum yaw rate based on the maximum yaw rate.

In some embodiments, the vehicle sideslip angle constraint information includes: the first vehicle sideslip angle constraint information of the left front wheel, the second vehicle sideslip angle constraint information of the right front wheel, the third vehicle sideslip angle constraint information of the left rear wheel, and the fourth vehicle sideslip angle constraint information of the right rear wheel. The first prediction module 4553 is further used to: perform the first constraint analysis processing based on the longitudinal vehicle speed of the vehicle in the first region, the first distance from the center of gravity of the vehicle to the front axle of the vehicle, the front wheel steering angle, the first saturation sideslip angle of the left front wheel and the rear track width to obtain the first vehicle sideslip angle constraint information; perform the second constraint analysis processing based on the longitudinal vehicle speed, the first distance, the front wheel steering angle, the second saturation sideslip angle of the right front wheel and the rear track width to obtain the second vehicle sideslip angle constraint information; perform the third constraint analysis processing based on the longitudinal vehicle speed, the second distance from the center of gravity of the vehicle to the rear axle of the vehicle, the third saturation sideslip angle of the left rear wheel and the front track width to obtain the third vehicle sideslip angle constraint information; and perform the fourth constraint analysis processing based on the longitudinal vehicle speed, the second distance, the fourth saturation sideslip angle of the right rear wheel and the front track width to obtain the fourth vehicle sideslip angle constraint information.

In some embodiments, the first vehicle sideslip angle constraint information includes the minimum vehicle sideslip angle and the maximum vehicle sideslip angle of the left front wheel. The first prediction module 4553 is further used to: obtain the first transformation value based on the difference between the front wheel steering angle and the first saturation sideslip angle; obtain the second transformation value based on the sum of the front wheel steering angle and the first saturation sideslip angle; obtain the first constraint value based on the longitudinal vehicle speed and the first distance, and obtain the second constraint value based on the first transformation value, the longitudinal vehicle speed and the rear track width; obtain the third constraint value based on the first constraint value, the second constraint value, and the yaw rate, and obtain the minimum vehicle sideslip angle of the left front wheel based on the third constraint value and the first transformation value; obtain the fourth constraint value based on the second transformation value, the longitudinal vehicle speed and the rear track width; and obtain the fifth constraint value based on the first constraint value, the fourth constraint value, and the yaw rate, and obtain the maximum vehicle sideslip angle of the left front wheel based on the fifth constraint value and the second transformation value.

In some embodiments, the second prediction module 4554 is further used to: discretize the lateral stability constraint information to obtain the discrete lateral stability constraint information; obtain the control increment constraint information of the front wheel steering angle, the control quantity constraint information of the front wheel steering angle and the vehicle system output quantity constraint information in the model predictive controller; and calculate the minimum constraint value of the cost function based on the discrete lateral stability constraint information, the control increment constraint information, the control quantity constraint information and the vehicle system output quantity constraint information, and obtain the control quantity of the front wheel steering angle corresponding to the minimum constraint value as the first control quantity.

In some embodiments, the second determination module 4555 is further used to: obtain the first vehicle state quantity corresponding to the minimum constraint value and the second vehicle state quantity corresponding to the actual state of the vehicle, wherein the first vehicle state quantity includes the first position and the first yaw angle of the center of gravity of the vehicle, and the second vehicle state quantity includes the second position and the second yaw angle of the center of gravity of the vehicle; obtain the distance error between the first position and the second position and the angle error between the first yaw angle and the second yaw angle; perform the weighting processing on the angle error based on the preset weight coefficient to obtain the weighted angle error, and obtain the control error based on the weighted angle error and the distance error; and adjust the control error based on the preset proportional coefficient, the preset integral coefficient, the preset derivative coefficient and the preset sampling interval to obtain the feedback compensation control quantity of the vehicle.

Embodiments of the present disclosure provide a computer program product. The computer program product includes computer-executable instructions or computer programs, which are stored in a computer-readable storage medium. A processor of an electronic device reads the computer-executable instructions or the computer programs from the computer-readable storage medium, and executes the computer-executable instructions or the computer programs, enabling the electronic device to perform the aforementioned vehicle data processing method of the embodiments of the present disclosure.

An embodiment of the present disclosure provides an autonomous vehicle including a processor and a non-transitory memory coupled to the processor. One or more computer programs are stored in the non-transitory memory and executable on the processor. The one or more computer programs include instructions for executing the vehicle data processing method provided in the embodiments of the present disclosure, for example, the vehicle data processing method shown in FIG. 3A.

An embodiment of the present disclosure provides a non-transitory computer-readable storage medium storing computer-executable instructions or one or more computer programs, and when the computer-executable instructions or one or more computer programs are executed by a processor, the processor is caused to execute the vehicle data processing method provided in the embodiments of the present disclosure, for example, the vehicle data processing method shown in FIG. 3A.

In some embodiments, the non-transitory computer-readable storage medium may be a memory, such as FRAM, ROM, PROM, EPROM, EEPROM, flash memory, magnetic surface memory, optical disc, CD-ROM, etc., or it may further be various devices including one of the aforementioned memories or any combination thereof.

In some embodiments, the computer-executable instructions may be in the form of programs, software, software modules, scripts, or code, written in any form of programming languages (including compiled or interpreted languages, or declarative or procedural languages), and may be deployed in any form, including being deployed as a standalone program or as a module, component, subroutine, or other units suitable for use in a computing environment.

As an example, the computer-executable instructions may, but need not necessarily, correspond to files in a file system, they may be stored as a part of a file storing other programs or data, for example, stored in one or more scripts contained in a Hyper Text Markup Language (HTML) document, in a single file dedicated to the program in question, or in a plurality of cooperative files (e.g., files storing one or more modules, subroutines, or code segments).

As an example, the computer-executable instructions may be deployed to be executed on one electronic device, on a plurality of electronic devices located at one location, or on a plurality of electronic devices distributed across a plurality of locations and interconnected through the communication network.

The foregoing are merely embodiments of the present disclosure, and are not intended to limit the protection scope of the present disclosure. Any modifications, equivalent replacements, and improvements made within the spirit and scope of the present disclosure shall be included within the protection scope of the present disclosure.

What is claimed is:

1. A computer-implemented vehicle data processing method, applied to an electronic device, wherein the electronic device is connected to a vehicle via a network, and the method comprises:
obtaining, by the electronic device, a yaw rate and a vehicle sideslip angle of the vehicle during driving, and constructing a phase plane diagram configured to characterize lateral vehicle dynamics state based on the yaw rate and the vehicle sideslip angle;
identifying, by the electronic device, a first region in the phase plane diagram by performing dynamic stability analysis of the vehicle on the phase plane diagram, wherein the first region is a region where the vehicle can travel along a preset trajectory without deviating from the preset trajectory by more than a threshold distance;
predicting, by the electronic device, lateral stability constraint information of the vehicle state within a preset horizon based on boundary characteristics of the first region;
designing, by the electronic device, a cost function of a model predictive controller of the vehicle, and obtaining a first control quantity through receding horizon control based on the lateral stability constraint information and the cost function; and
obtaining, by the electronic device, a feedback compensation control quantity of the vehicle, obtaining a second control quantity based on the first control quantity and the feedback compensation control quantity, and controlling the vehicle to perform closed-loop trajectory tracking based on the second control quantity and a reference trajectory, wherein the second control quantity is a composite control quantity.

2. The method of claim 1, wherein identifying the first region in the phase plane diagram by performing the dynamic stability analysis of the vehicle on the phase plane diagram comprises:
obtaining an equilibrium point and N phase trajectories of the vehicle in the phase plane diagram, wherein N is a positive integer;
selecting at least one target phase trajectory converging to the equilibrium point from the N phase trajectories; and
identifying a region occupied by the at least one target phase trajectory in the phase plane diagram as the first region.

3. The method of claim 1, wherein predicting the lateral stability constraint information of the vehicle state within the preset horizon based on the boundary characteristics of the first region comprises:
obtaining yaw rate constraint information of the vehicle in the first region, and obtaining vehicle sideslip angle constraint information of the vehicle in the first region;
obtaining a boundary value of the front wheel steering angle of the vehicle by performing boundary value prediction based on the yaw rate constraint information and the vehicle sideslip angle constraint information; and
obtaining the lateral stability constraint information by performing vehicle state constraint prediction based on the yaw rate constraint information, the vehicle sideslip angle constraint information, and the boundary value of the front wheel steering angle.

4. The method of claim 3, wherein the yaw rate constraint information comprises a minimum yaw rate and a maximum yaw rate, and obtaining the yaw rate constraint information of the vehicle in the first region comprises:
obtaining a longitudinal vehicle speed and a road adhesion coefficient of the vehicle in the first region;
obtaining the maximum yaw rate based on the longitudinal vehicle speed, the road adhesion coefficient and gravitational acceleration; and
obtaining the minimum yaw rate based on the maximum yaw rate.

5. The method of claim 4, wherein the vehicle sideslip angle constraint information comprises: first vehicle sideslip angle constraint information of a left front wheel of the vehicle, second vehicle sideslip angle constraint information of a right front wheel of the vehicle, third vehicle sideslip angle constraint information of a left rear wheel of the vehicle, and fourth vehicle sideslip angle constraint information of a right rear wheel of the vehicle, and obtaining the vehicle sideslip angle constraint information of the vehicle in the first region comprises:
obtaining the first vehicle sideslip angle constraint information by performing a first constraint analysis processing based on the longitudinal vehicle speed of the vehicle in the first region, a first distance from the center of gravity of the vehicle to a front axle of the vehicle, a front wheel steering angle, a first saturation sideslip angle of the left front wheel, and a rear track width;
obtaining the second vehicle sideslip angle constraint information by performing a second constraint analysis processing based on the longitudinal vehicle speed, the first distance, the front wheel steering angle, a second saturation sideslip angle of the right front wheel, and the rear track width;
obtaining the third vehicle sideslip angle constraint information by performing a third constraint analysis processing based on the longitudinal vehicle speed, a second distance from the center of gravity of the vehicle to a rear axle of the vehicle, a third saturation sideslip angle of the left rear wheel, and a front track width; and
obtaining the fourth vehicle sideslip angle constraint information by performing a fourth constraint analysis processing based on the longitudinal vehicle speed, the second distance, a fourth saturation sideslip angle of the right rear wheel, and the front track width.

6. The method of claim 5, wherein the first vehicle sideslip angle constraint information comprises: a minimum vehicle sideslip angle of the left front wheel, and a maximum vehicle sideslip angle of the left front wheel; and
wherein obtaining the first vehicle sideslip angle constraint information by performing the first constraint analysis processing based on the longitudinal vehicle speed of the vehicle in the first region, the first distance from the center of gravity of the vehicle to the front axle of the vehicle, the front wheel steering angle, the first saturation sideslip angle of the left front wheel, and the rear track width comprises:
obtaining a first transformation value based on a difference between the front wheel steering angle and the first saturation sideslip angle, and obtaining a second transformation value based on a sum of the front wheel steering angle and the first saturation sideslip angle;
obtaining a first constraint value based on the longitudinal vehicle speed and the first distance, and obtaining a second constraint value based on the first transformation value, the longitudinal vehicle speed, and the rear track width;
obtaining a third constraint value based on the first constraint value, the second constraint value and the yaw rate, and obtaining the minimum vehicle sideslip angle of the left front wheel based on the third constraint value and the first transformation value;
obtaining a fourth constraint value based on the second transformation value, the longitudinal vehicle speed, and the rear track width; and
obtaining a fifth constraint value based on the first constraint value, the fourth constraint value and the yaw rate, and obtaining the maximum vehicle sideslip angle of the left front wheel based on the fifth constraint value and the second transformation value.

7. The method of claim 3, wherein obtaining the first control quantity through receding horizon control based on the lateral stability constraint information and the cost function comprises:
discretizing the lateral stability constraint information to obtain the discrete lateral stability constraint information;
obtaining control increment constraint information of the front wheel steering angle, control quantity constraint information of the front wheel steering angle, and vehicle system output quantity constraint information in the model predictive controller; and
calculating a minimum constraint value of the cost function based on the discrete lateral stability constraint information, the control increment constraint information, the control quantity constraint information, and the vehicle system output quantity constraint information, and obtaining a control quantity of the front wheel steering angle corresponding to the minimum constraint value as the first control quantity.

8. The method of claim 1, wherein obtaining the feedback compensation control quantity of the vehicle comprises:
obtaining a first vehicle state quantity corresponding to the minimum constraint value, and a second vehicle state quantity corresponding to an actual state of the vehicle, wherein the first vehicle state quantity comprises: a first position and a first yaw angle of a center of gravity of the vehicle, and the second vehicle state quantity comprises: a second position and a second yaw angle of the center of gravity of the vehicle;
obtaining a distance error between the first position and the second position, and an angle error between the first yaw angle and the second yaw angle;
performing a weighting processing on the angle error based on a preset weight coefficient to obtain a weighted angle error, and obtaining a control error based on the weighted angle error and the distance error; and
obtaining the feedback compensation control quantity of the vehicle by adjusting the control error based on a preset proportional coefficient, a preset integral coefficient, a preset derivative coefficient, and a preset sampling interval.

9. An autonomous vehicle, comprising:
a processor;
a memory coupled to the processor; and
one or more computer programs stored in the memory and executable on the processor;
wherein, the one or more computer programs comprise:
instructions for obtaining a yaw rate and a vehicle sideslip angle of the vehicle during driving, and constructing a phase plane diagram configured to characterize lateral vehicle dynamics state based on the yaw rate and the vehicle sideslip angle;
instructions for identifying a first region in the phase plane diagram by performing dynamic stability analysis of the vehicle on the phase plane diagram, wherein the first region is a region where the vehicle can travel stably along a preset trajectory;
instructions for predicting lateral stability constraint information of the vehicle state within a preset horizon based on boundary characteristics of the first region;
instructions for designing a cost function of a model predictive controller of the vehicle, and obtaining a first control quantity through receding horizon control based on the lateral stability constraint information and the cost function; and
instructions for obtaining a feedback compensation control quantity of the vehicle, obtaining a second control quantity based on the first control quantity and the feedback compensation control quantity, and controlling the vehicle to perform closed-loop trajectory tracking based on the second control quantity and a reference trajectory, wherein the second control quantity is a composite control quantity.

10. The autonomous vehicle of claim 9, wherein the instructions for identifying the first region in the phase plane diagram by performing the dynamic stability analysis of the vehicle on the phase plane diagram comprise:
instructions for obtaining an equilibrium point and N phase trajectories of the vehicle in the phase plane diagram, wherein N is a positive integer;
instructions for selecting at least one target phase trajectory converging to the equilibrium point from the N phase trajectories; and
instructions for identifying a region occupied by the at least one target phase trajectory in the phase plane diagram as the first region.

11. The autonomous vehicle of claim 9, wherein the instructions for predicting the lateral stability constraint information of the vehicle state within the preset horizon based on the boundary characteristics of the first region comprise:
instructions for obtaining yaw rate constraint information of the vehicle in the first region, and obtaining vehicle sideslip angle constraint information of the vehicle in the first region;
instructions for obtaining a boundary value of the front wheel steering angle of the vehicle by performing boundary value prediction based on the yaw rate constraint information and the vehicle sideslip angle constraint information; and
instructions for obtaining the lateral stability constraint information by performing vehicle state constraint prediction based on the yaw rate constraint information, the vehicle sideslip angle constraint information, and the boundary value of the front wheel steering angle.

12. The autonomous vehicle of claim 11, wherein the yaw rate constraint information comprises a minimum yaw rate and a maximum yaw rate, and the instructions for obtaining the yaw rate constraint information of the vehicle in the first region comprise:
instructions for obtaining a longitudinal vehicle speed and a road adhesion coefficient of the vehicle in the first region;
instructions for obtaining the maximum yaw rate based on the longitudinal vehicle speed, the road adhesion coefficient and gravitational acceleration; and
instructions for obtaining the minimum yaw rate based on the maximum yaw rate.

13. The autonomous vehicle of claim 12, wherein the vehicle sideslip angle constraint information comprises: first vehicle sideslip angle constraint information of a left front wheel of the vehicle, second vehicle sideslip angle constraint information of a right front wheel of the vehicle, third vehicle sideslip angle constraint information of a left rear wheel of the vehicle, and fourth vehicle sideslip angle constraint information of a right rear wheel of the vehicle, and the instructions for obtaining the vehicle sideslip angle constraint information of the vehicle in the first region comprise:
instructions for obtaining the first vehicle sideslip angle constraint information by performing a first constraint analysis processing based on the longitudinal vehicle speed of the vehicle in the first region, a first distance from the center of gravity of the vehicle to a front axle of the vehicle, a front wheel steering angle, a first saturation sideslip angle of the left front wheel, and a rear track width;
instructions for obtaining the second vehicle sideslip angle constraint information by performing a second constraint analysis processing based on the longitudinal vehicle speed, the first distance, the front wheel steering angle, a second saturation sideslip angle of the right front wheel, and the rear track width;
instructions for obtaining the third vehicle sideslip angle constraint information by performing a third constraint analysis processing based on the longitudinal vehicle speed, a second distance from the center of gravity of the vehicle to a rear axle of the vehicle, a third saturation sideslip angle of the left rear wheel, and a front track width; and
instructions for obtaining the fourth vehicle sideslip angle constraint information by performing a fourth constraint analysis processing based on the longitudinal vehicle speed, the second distance, a fourth saturation sideslip angle of the right rear wheel, and the front track width.

14. The autonomous vehicle of claim 13, wherein the first vehicle sideslip angle constraint information comprises: a minimum vehicle sideslip angle of the left front wheel, and a maximum vehicle sideslip angle of the left front wheel; and
wherein the instructions for obtaining the first vehicle sideslip angle constraint information by performing the first constraint analysis processing based on the longitudinal vehicle speed of the vehicle in the first region, the first distance from the center of gravity of the vehicle to the front axle of the vehicle, the front wheel steering angle, the first saturation sideslip angle of the left front wheel, and the rear track width comprise:
instructions for obtaining a first transformation value based on a difference between the front wheel steering angle and the first saturation sideslip angle, and obtaining a second transformation value based on a sum of the front wheel steering angle and the first saturation sideslip angle;
instructions for obtaining a first constraint value based on the longitudinal vehicle speed and the first distance, and obtaining a second constraint value based on the first transformation value, the longitudinal vehicle speed, and the rear track width;
instructions for obtaining a third constraint value based on the first constraint value, the second constraint value and the yaw rate, and obtaining the minimum vehicle sideslip angle of the left front wheel based on the third constraint value and the first transformation value;
instructions for obtaining a fourth constraint value based on the second transformation value, the longitudinal vehicle speed, and the rear track width; and
instructions for obtaining a fifth constraint value based on the first constraint value, the fourth constraint value and the yaw rate, and obtaining the maximum vehicle sideslip angle of the left front wheel based on the fifth constraint value and the second transformation value.

15. The autonomous vehicle of claim 11, wherein the instructions for obtaining the first control quantity through receding horizon control based on the lateral stability constraint information and the cost function comprise:
instructions for discretizing the lateral stability constraint information to obtain the discrete lateral stability constraint information;
instructions for obtaining control increment constraint information of the front wheel steering angle, control quantity constraint information of the front wheel steering angle, and vehicle system output quantity constraint information in the model predictive controller; and
instructions for calculating a minimum constraint value of the cost function based on the discrete lateral stability constraint information, the control increment constraint information, the control quantity constraint information, and the vehicle system output quantity constraint information, and obtaining a control quantity of the front wheel steering angle corresponding to the minimum constraint value as the first control quantity.

16. The autonomous vehicle of claim 9, wherein the instructions for obtaining the feedback compensation control quantity of the vehicle comprise:
instructions for obtaining a first vehicle state quantity corresponding to the minimum constraint value, and a second vehicle state quantity corresponding to an actual state of the vehicle, wherein the first vehicle state quantity comprises: a first position and a first yaw angle of a center of gravity of the vehicle, and the second vehicle state quantity comprises: a second position and a second yaw angle of the center of gravity of the vehicle;
instructions for obtaining a distance error between the first position and the second position, and an angle error between the first yaw angle and the second yaw angle;
instructions for performing a weighting processing on the angle error based on a preset weight coefficient to obtain a weighted angle error, and obtaining a control error based on the weighted angle error and the distance error; and
instructions for obtaining the feedback compensation control quantity of the vehicle by adjusting the control error based on a preset proportional coefficient, a preset integral coefficient, a preset derivative coefficient, and a preset sampling interval.

17. A non-transitory computer-readable storage medium for storing computer-executable instructions or one or more computer programs, wherein the computer-executable instructions or the one or more computer programs, when executed by a processor, implement a vehicle data processing method comprising:
obtaining a yaw rate and a vehicle sideslip angle of the vehicle during driving, and constructing a phase plane diagram configured to characterize lateral vehicle dynamics state based on the yaw rate and the vehicle sideslip angle;
identifying a first region in the phase plane diagram by performing dynamic stability analysis of the vehicle on the phase plane diagram, wherein the first region is a region where the vehicle can travel stably along a preset trajectory;
predicting lateral stability constraint information of the vehicle state within a preset horizon based on boundary characteristics of the first region;
designing a cost function of a model predictive controller of the vehicle, and obtaining a first control quantity through receding horizon control based on the lateral stability constraint information and the cost function; and
obtaining a feedback compensation control quantity of the vehicle, obtaining a second control quantity based on the first control quantity and the feedback compensation control quantity, and controlling the vehicle to perform closed-loop trajectory tracking based on the second control quantity and a reference trajectory, wherein the second control quantity is a composite control quantity.

18. The non-transitory computer-readable storage medium of claim 17, wherein identifying the first region in the phase plane diagram by performing the dynamic stability analysis of the vehicle on the phase plane diagram comprises:
obtaining an equilibrium point and N phase trajectories of the vehicle in the phase plane diagram, wherein N is a positive integer;
selecting at least one target phase trajectory converging to the equilibrium point from the N phase trajectories; and
identifying a region occupied by the at least one target phase trajectory in the phase plane diagram as the first region.

19. The non-transitory computer-readable storage medium of claim 17, wherein predicting the lateral stability constraint information of the vehicle state within the preset horizon based on the boundary characteristics of the first region comprises:
obtaining yaw rate constraint information of the vehicle in the first region, and obtaining vehicle sideslip angle constraint information of the vehicle in the first region;
obtaining a boundary value of the front wheel steering angle of the vehicle by performing boundary value prediction based on the yaw rate constraint information and the vehicle sideslip angle constraint information; and
obtaining the lateral stability constraint information by performing vehicle state constraint prediction based on the yaw rate constraint information, the vehicle sideslip angle constraint information, and the boundary value of the front wheel steering angle.

20. The non-transitory computer-readable storage medium of claim 17, wherein obtaining the feedback compensation control quantity of the vehicle comprises:
obtaining a first vehicle state quantity corresponding to the minimum constraint value, and a second vehicle state quantity corresponding to an actual state of the vehicle, wherein the first vehicle state quantity comprises: a first position and a first yaw angle of a center of gravity of the vehicle, and the second vehicle state quantity comprises: a second position and a second yaw angle of the center of gravity of the vehicle;
obtaining a distance error between the first position and the second position, and an angle error between the first yaw angle and the second yaw angle;
performing a weighting processing on the angle error based on a preset weight coefficient to obtain a weighted angle error, and obtaining a control error based on the weighted angle error and the distance error; and
obtaining the feedback compensation control quantity of the vehicle by adjusting the control error based on a preset proportional coefficient, a preset integral coefficient, a preset derivative coefficient, and a preset sampling interval.
